(19) United States
(12) Patent Application Publication
(10) Pub. No.: US 2022/0055337 A1
(43) Pub. Date: Feb. 24, 2022

(54) FLEXIBLE THERMAL INSULATION ASSEMBLY AND METHOD FOR THERMALLY INSULATING A SNOW HEAP

(71) Applicant: GLACIES TECHNOLOGIES INC., Quebec (CA)

(72) Inventors: Maxim Bergeron, Quebec (CA); Mathieu Kirouac, Sherbrooke (CA)

(73) Assignee: GLACIES TECHNOLOGIES INC., Quebec, QC (CA)

(21) Appl. No.: 17/413,462

(22) PCT Filed: Dec. 13, 2019
(86) PCT No.: PCT/CA2019/051802

§ 371 Date: Jun. 11, 2021

Related U.S. Application Data
(60) Provisional application No. 62/779,076, filed on Dec. 13, 2018.

(51) Int. Cl. B32B 3/14; B32B 3/26; B32B 3/06; B32B 27/30; B32B 27/40; B32B 5/18; B32B 27/32; B32B 5/02; B32B 27/08; B32B 27/06; B32B 27/12; B32B 5/24; F16L 59/02; E04B 1/32; E04C 2/296; E04B 2/00

(52) U.S. Cl. CPC B32B 3/14; E04B 2103/04; B32B 3/06; B32B 27/302; B32B 27/40; B32B 5/18; B32B 27/32; B32B 27/304; B32B 27/322; B32B 5/02; B32B 27/08; B32B 27/065; B32B 27/12; B32B 5/245; F16L 59/029; E04B 1/3211; E04C 2/296; E04C 2/44; B32B 2307/304; B32B 2307/71; B32B 2307/416; B32B 2307/7265; B32B 2272/00; B32B 2262/101; B32B 2307/546; E04B 2001/3235; E04B 2001/3252; B32B 3/26

(57) ABSTRACT

The present disclosure concerns a flexible thermal insulation assembly to thermally insulate matter from an external environment, the flexible thermal insulation assembly comprising a plurality of thermal insulation covering sections comprising an outer layer and an insulated matter-facing layer, the plurality of thermal insulation covering sections being configurable in an adjacent configuration wherein the plurality of thermal insulation covering sections are articulately connected to one another to substantially conform to an outer surface of the insulated matter; and an insulated matter-mounting assembly securing the plurality of thermal insulation covering sections onto the insulated matter with the insulated matter-facing layers of the plurality of thermal insulation covering sections at least partially covering the insulated matter and substantially conforming thereto. The present disclosure also concerns a method for thermally insulating matter, such as a snow heap, from an external environment.

### PRIOR APPLICATION

The present application claims priority from U.S. provisional patent application No. 62/779.076, filed on Dec. 13, 2018, and entitled “THERMAL INSULATION COVERING ASSEMBLY FOR SNOW HEAP”, the disclosure of which being hereby incorporated by reference in its entirety.

### TECHNICAL FIELD

The technical field relates to a thermal insulation assembly, and more particularly to a flexible thermal insulation assembly to thermally insulate matter, for instance forming a heap, such as a heap of ice or snow, and to a method for thermally insulating matter, for instance a snow heap or an ice heap.

### BACKGROUND

During winters, in some countries, large amounts of snow or ice can be formed. These snow or ice heaps melt during warm weather. For different purposes, such as in order to provide ski resorts with snow despite unfavorable weather conditions, it might be useful to reduce the snow or ice melt for the snow or ice to be used later. Some insulation assemblies exist that are usually heavy and rigid, and thus do not properly cover and isolate the snow heap. Wood chips might also be used, but are neither satisfactory.

In view of the above, there is a need for a snow heap thermal insulation assembly which would be able to overcome or at least minimize some of the above-discussed prior art concerns.

### BRIEF SUMMARY

It is therefore an aim of the present invention to address the above-mentioned issues.

According to a general aspect, there is provided a flexible thermal insulation assembly to thermally insulate matter from an external environment, the flexible thermal insulation assembly comprising a plurality of thermal insulation covering sections comprising an outer layer and an insulated matter-facing layer, the plurality of thermal insulation covering sections being configurable in an adjacent configuration wherein the plurality of thermal insulation covering sections are articulately connected to one another to substantially conform to an outer surface of the insulated matter; and an insulated matter-mounting assembly securing the plurality of thermal insulation covering sections onto the insulated matter with the insulated matter-facing layers of the plurality of thermal insulation covering sections at least partially covering the insulated matter and substantially conforming thereto.

According to another general aspect, there is provided a flexible thermal insulation assembly to thermally insulate matter from an external environment, the flexible thermal insulation assembly comprising a plurality of thermal insulation covering sections comprising an outer layer and an insulated matter-facing layer, the plurality of thermal insulation covering sections being configurable in an adjacent configuration wherein the plurality of thermal insulation covering sections are articulately connected to one another to substantially conform to an outer surface of the insulated matter; and an insulated matter-mounting assembly securing the plurality of thermal insulation covering sections onto the insulated matter, the insulated matter-mounting assembly comprising one or more covering section-fastening links securing together at least some of the plurality of thermal insulation covering sections and providing an articulated connection inbetween, with the insulated matter-facing layers of the plurality of thermal insulation covering sections at least partially covering the insulated matter and substantially conforming thereto.

According to another general aspect, there is provided a method for thermally insulating a snow heap supported on a ground surface from an external environment, the method comprising: providing a plurality of thermal insulation covering sections comprising an outer layer and a snow heap-facing layer; configuring the plurality of thermal insulation covering sections in an adjacent configuration onto the snow heap with the plurality of thermal insulation covering sections being articulately connected to one another to substantially conform to an outer surface of the snow heap; and securing the plurality of thermal insulation covering sections onto the snow heap with the snow heap-facing layers of the plurality of thermal insulation covering sections at least partially covering the snow heap and substantially conforming thereto.

According to another general aspect, there is provided a flexible snow heap thermal insulation covering comprising at least one thermal insulation covering section. Each one of the at least one thermal insulation covering section comprises a heap-facing layer and an outer layer at least partially secured to the heap-facing layer and defining therewith at least one insulation chamber, wherein the at least one insulation chamber includes at least one insulation material filling opening formed in one of the heap-facing layer and the outer layer or inbetween the heap-facing layer and the outer layer.

According to another general aspect of the disclosure, there is provided a thermal insulation covering assembly comprising a flexible snow heap thermal insulation covering according to the present disclosure and insulation material filling at least partially said at least one insulation chamber.

According to another general aspect of the disclosure, there is provided a method for forming a thermal insulation assembly comprising providing a flexible snow heap thermal insulation covering according to the present disclosure and filling at least partially the at least one insulation chamber with an insulation material.

In an embodiment, the method for forming a thermal insulation assembly further comprises providing a plurality of thermal insulation covering sections and assembling together said plurality of thermal insulation covering sections.

According to another general aspect of the disclosure, there is provided a method for thermally isolating a snow heap, comprising providing a thermal insulation assembly according to the present disclosure, at least partially covering the snow heap with the thermal insulation assembly and securing the thermal insulation assembly to a ground surrounding the snow heap and/or to the snow heap.

In this specification, the term “snow” is intended to mean “frozen/solid water” and includes ice.

### BRIEF DESCRIPTION OF THE DRAWINGS

FIG. 1 is a side cross-section view of a flexible thermal insulation assembly in accordance with an embodiment, the flexible thermal insulation assembly comprising a plurality of thermal insulation covering sections assembled together in an adjacent configuration, and an insulated matter-mounting assembly;

FIG. 1A is an enlarged portion of the thermal insulation assembly of FIG. 1;

FIG. 2 is a top perspective view of a portion of a thermal insulation covering section in accordance with an embodiment;

FIG. 3 is a top perspective view, partially sectioned, of the thermal insulation covering section of FIG. 2, the thermal insulation covering section defining a thermal insulation chamber with a plurality of thermal insulation cushions and covering stiffeners being arranged therein;

FIG. 4 is a top perspective view of one of the thermal insulation cushions of FIG. 3;

FIG. 5 is a top perspective view of one of the covering stiffeners of FIG. 3;

FIG. 6A is a cross-section view of a thermal insulation covering section in accordance with another embodiment;

FIG. 6B is a cross-section view of a thermal insulation covering section in accordance with another embodiment;

FIG. 7 is a top perspective cross-section view of a thermal insulation covering section in accordance with another embodiment;

FIG. 8 is a top perspective cross-section view of a thermal insulation covering section in accordance with another embodiment;

FIG. 9 is a top perspective view of a flexible thermal insulation assembly in accordance with another embodiment, one of the thermal insulation covering sections being partially sectioned and defining a thermal insulation chamber with a plurality of thermal insulation cushions arranged therein;

FIG. 10 is a top perspective view of one of the thermal insulation covering sections of FIG. 9;

FIG. 11 is a top perspective view of one of the thermal insulation cushions of FIG. 9, the thermal insulation cushion being filled with insulating material;

FIG. 12 is a top perspective view of the thermal insulation cushion of FIG. 11, with no insulating material therein;

FIG. 13 is a top perspective cross-section view of a thermal insulation covering section in accordance with another embodiment;

FIG. 14 is a top perspective view, partially sectioned, of a flexible thermal insulation assembly in accordance with another embodiment, the thermal insulation assembly comprising a plurality of thermal insulation covering sections and a plurality of covering section couplers arranged therebetween;

FIG. 15 is a top plan view of one of the thermal insulation covering sections of FIG. 14;

FIG. 16 is top cross-section view of the thermal insulation covering section of FIG. 15;

FIGS. 17A and 17B are top and bottom perspective views of one of the covering section couplers of FIG. 14;

FIG. 18 is a side cross-section view of a flexible thermal insulation assembly in accordance with another embodiment;

FIG. 19 is a top perspective view, partially sectioned, of a flexible thermal insulation assembly in accordance with another embodiment, the thermal insulation assembly comprising a plurality of thermal insulation covering sections having a thermal insulation body with inner reinforcing grids arranged therein;

FIG. 20 is a top perspective view of one of the thermal insulation covering sections of FIG. 19;

FIG. 21 is a side cross-section view of the thermal insulation covering section of FIG. 20;

FIG. 22 is a side cross-section view of a thermal insulation covering section in accordance with another embodiment;

FIG. 23 is a top perspective view, sectioned, of a thermal insulation covering section in accordance with another embodiment, a fastener-receiving opening being formed in the covering section;

FIG. 24 is a top perspective view of two adjacent thermal insulation covering sections in accordance with another embodiment, the covering sections comprising covering section connectors extending from a border thereof;

FIG. 25 is a block diagram representing the sequential steps of a method for forming a flexible thermal insulation assembly according to the present disclosure; and

FIG. 26 is a block diagram representing the sequential steps of a method for thermally insulating a snow heap with a snow heap thermal insulation assembly according to the present disclosure.

### DETAILED DESCRIPTION

In the following description, the same numerical references refer to similar elements. Furthermore, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional, and are given for exemplification purposes only.

Moreover, it will be appreciated that positional descriptions such as “above”, “below”, “forward”, “rearward”, “left”, “right” and the like should, unless otherwise indicated, be taken in the context of the figures only and should not be considered limiting. Moreover, the figures are meant to be illustrative of certain characteristics of the flexible thermal insulation assembly and are not necessarily to scale.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the following description, an embodiment is an example or implementation. The various appearances of “one embodiment”, “an embodiment” or “some embodiments” do not necessarily all refer to the same embodiments. Although various features may be described in the context of a single embodiment, the features may also be provided separately or in any suitable combination. Conversely, although the invention may be described herein in the context of separate embodiments for clarity, it may also be implemented in a single embodiment. Reference in the specification to “some embodiments”, “an embodiment”, “one embodiment” or “other embodiments” means that a particular feature, structure, or characteristic described in connection with the embodiments is included in at least some embodiments, but not necessarily all embodiments.

It is to be understood that the phraseology and terminology employed herein is not to be construed as limiting and are for descriptive purpose only. The principles and uses of the teachings of the present disclosure may be better understood with reference to the accompanying description, figures and examples. It is to be understood that the details set forth herein do not construe a limitation to an application of the disclosure.

Furthermore, it is to be understood that the disclosure can be carried out or practiced in various ways and that the disclosure can be implemented in embodiments other than the ones outlined in the description above. It is to be understood that the terms “including”, “comprising”, and grammatical variants thereof do not preclude the addition of one or more components, features, steps, or integers or groups thereof and that the terms are to be construed as specifying components, features, steps or integers. If the specification or claims refer to “an additional” element, that does not preclude there being more than one of the additional element. It is to be understood that where the claims or specification refer to “a” or “an” element, such reference is not be construed that there is only one of that element. It is to be understood that where the specification states that a component, feature, structure, or characteristic “may”, “might”, “can” or “could” be included, that particular component, feature, structure, or characteristic is not required to be included.

In the following description, it is understood that the term “insulation” will refer, unless otherwise specified, to “thermal insulation”.

The descriptions, examples, methods and materials presented in the claims and the specification are not to be construed as limiting but rather as illustrative only. Meanings of technical and scientific terms used herein are to be commonly understood as by one of ordinary skill in the art to which the invention belongs, unless otherwise defined. It will be appreciated that the methods described herein may be performed in the described order, or in any suitable order.

### Flexible Thermal Insulation Assembly

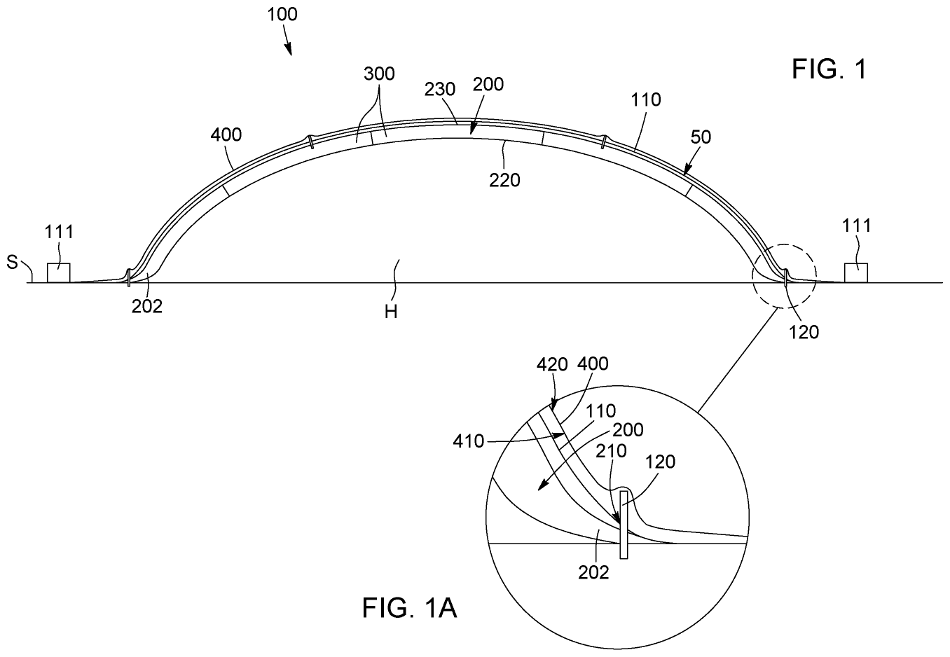

Referring now to the drawings, and more particularly to FIG. 1, there is shown a flexible thermal insulation assembly 100 (for instance a flexible snow heap thermal insulation assembly 100) comprising a plurality of thermal insulation covering sections 300 configured in an adjacent configuration and forming together a flexible snow heap thermal insulation covering 200. As detailed below, the plurality of thermal insulation covering sections comprises an outer layer and an insulated matter-facing layer (for instance a snow-heap facing layer in the embodiment wherein the thermal insulation assembly is used to thermally insulate a snow heap), the plurality of thermal insulation covering sections being configurable in an adjacent configuration wherein the plurality of thermal insulation covering sections are articulately connected to one another to substantially conform to an outer surface of the insulated matter. The snow heap thermal insulation assembly 100 further comprises an insulated matter-mounting assembly 50 (for instance a heap-mounting assembly 50) securing the plurality of thermal insulation covering sections 300 onto the insulated matter (for instance onto a snow heap H) with the insulated matter-facing layers of the plurality of thermal insulation covering sections at least partially covering the insulated matter and substantially conforming thereto. In the embodiment shown, the flexible snow heap thermal insulation assembly 100 is designed to cover and thermally insulate a snow (or ice) heap H supported on a ground surface S, but it could also be conceived to thermally insulate any other element or matter, such as ice, sand, soil . . . . The flexible snow heap thermal insulation assembly 100 can also be used on a flat surface or on any other material where it is desirable to insulate a surface or a matter from an external environment. In other words, the flexible thermal insulation assembly 100 in accordance with the present disclosure is configured to limit thermal exchanges between the covered heap or matter and the external environment. In yet other words, in the embodiments wherein the matter to be covered has a temperature smaller than a temperature of the external environment (i.e. smaller than a temperature of an area surrounding the matter to be covered), the flexible thermal insulation assembly 100 is configured to limit heat exchanges between the external environment and the covered insulated matter. The flexible thermal insulation assembly 100 can also be used to foster a thermal exchange between the insulated element (for instance snow or ice) and a fluid (including liquids and/or gases), for instance and without being limitative contained in a fluid conduct. The fluid conduct can be at least partially covered by the element to be thermally insulated from the external environment by the thermal insulation assembly 100 so as to improve the efficiency of the thermal exchange between the element and the fluid.

As detailed below, the thermal insulation covering sections 300 are at least partially made and/or comprise a thermal insulation chamber at least partially filled with an insulating material. Different embodiments of the thermal insulation covering sections 300 are possible, as well as different embodiments of the heap-mounting assembly 50 (or insulated matter-mounting assembly) configured to secure the thermal insulation covering sections 300 onto the snow heap S and/or to the ground surface S surrounding the snow heap H.

### Flexible Thermal Insulation Covering

The flexible thermal insulation covering 200 (for instance the flexible snow heap thermal insulation covering 200) comprising the plurality of adjacent thermal insulation covering sections 300 is superposable to an outer surface of the snow heap H, so as to at least partially cover, thermally insulate it and to substantially conform to the outer surface thereof. The snow heap thermal insulation covering 200 defines a heap-facing surface 220 (at least partially formed of heap-facing layers of the plurality of snow heap thermal insulation covering sections 300 in the adjacent configuration) directed towards and being configured to contact the insulated snow heap H, and an opposed outer surface 230. As detailed below, the plurality of the thermal insulation covering sections are articulately and/or pivotably connected to one another to provide some flexibility to the thermal insulation assembly 100 and for the thermal insulation covering 200 to substantially conform to the outer surface of the insulated matter. As detailed below, the thermal insulation covering sections can either be directly articulately and/or pivotably connected to one other or indirectly, via some elements—such as covering section couplers—of the insulated matter-mounting assembly 50. As detailed below, at least some of the plurality of thermal insulation covering sections 300 can at least partially be made of a material providing some flexibility to the thermal insulation assembly 100.

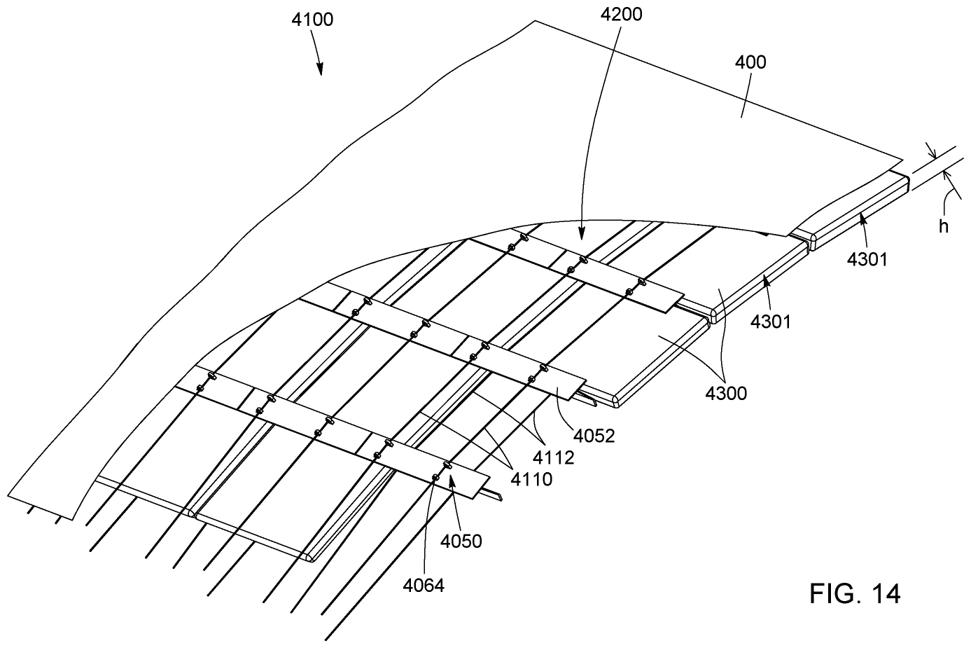

The thermal insulation covering 200 comprises a peripheral border 202. In some embodiments, the peripheral border 202 is configured to be at least partially supported on a portion of the ground surface S surrounding the snow heap H. In the embodiment shown, as detailed below, the heap-mounting assembly 50 of the thermal insulation assembly 100 comprises one or more fastening links 110 (or covering section-fastening links—FIG. 14) secured to the thermal insulation covering 200—for instance to the outer surface 230 thereof—and securable to the ground surface S and/or to the snow heap H with fasteners 120 (or ground fasteners or snow heap fasteners, such as, and without being limitative, stakes, poles or any other suitable mechanical fastener). The heap-mounting assembly 50, comprising for instance the fastening links 110, is thus configured to maintain the thermal insulation covering 200 over the snow heap H and to tense it, for the flexible snow heap thermal insulation covering 200 to substantially conform to a shape of the outer surface of the snow heap H and to remain substantially close to the outer surface of the snow heap H, even when partially melt, so as not to jeopardize the thermal insulation of the remaining snow of the snow heap H. The heap-mounting assembly 50, comprising for instance the fastening links 110, is further configured to secure the thermal insulation covering 200 in order to limit movements thereof (for instance due to slippage or wind).

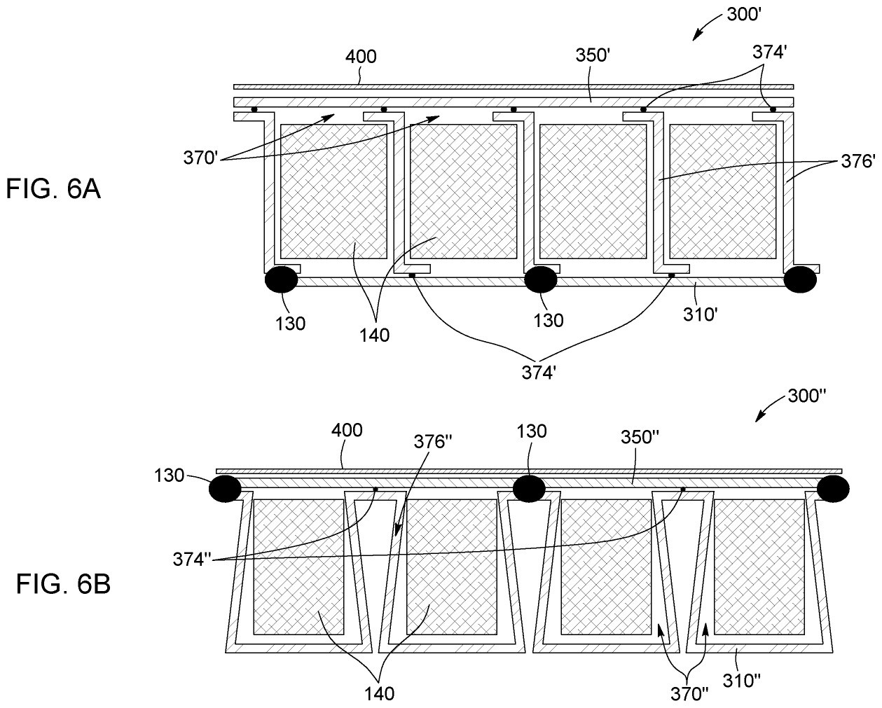

The heap-mounting assembly 50 could also comprise retention straps 130 (FIGS. 6A and 6B) (or retention bands) extending between two opposed peripheral borders 202 of the thermal insulation covering 200 or at least along a portion of the outer surface of the snow heap H, either on the outer surface 230 of the thermal insulation covering 200, or between the outer surface of the snow heap H and the thermal insulation covering 200 or within at least a portion of the thermal insulation covering 200. The retention strap might comprise one or more free ends forming fastening links. In the embodiment shown, the heap-mounting assembly 50 can comprise a plurality of retention straps extending substantially parallel to each other. In an embodiment, the retention straps can be adjustable in length. The retention straps might comprise wires or chains or any other longitudinal element suitable for extending between peripheral borders 202 of the thermal insulation covering 200 or at least along a portion of the outer surface of the snow heap H.

The flexible snow heap thermal insulation covering 200 might further comprise, as represented in FIG. 1, fastener-receiving openings 210, for instance formed in the peripheral border 202 or in any other part of the thermal insulation covering 200. The fastening links 110 can be engaged into the fastener-receiving openings 210 to secure the fastening links 110 to the thermal insulation covering 200, or fasteners 120 can directly be engaged into the fastener-receiving openings 210 to secure the thermal insulation covering 200 to the ground surface S and/or directly to the snow heap H.

The fastening links 110, either secured to the peripheral border 202 or introduced in the fastener-receiving openings 210, might be combined with any other suitable fasteners, such as heavy bags 111 (for instance bags filled with sand) disposed for instance on the peripheral border 202 of the thermal insulation covering 200. Ballasts or weights could further be provided, for instance in insulation chambers at least partially defined by the thermal insulation covering sections to further improve the stability of the thermal insulation assembly 100 when in use.

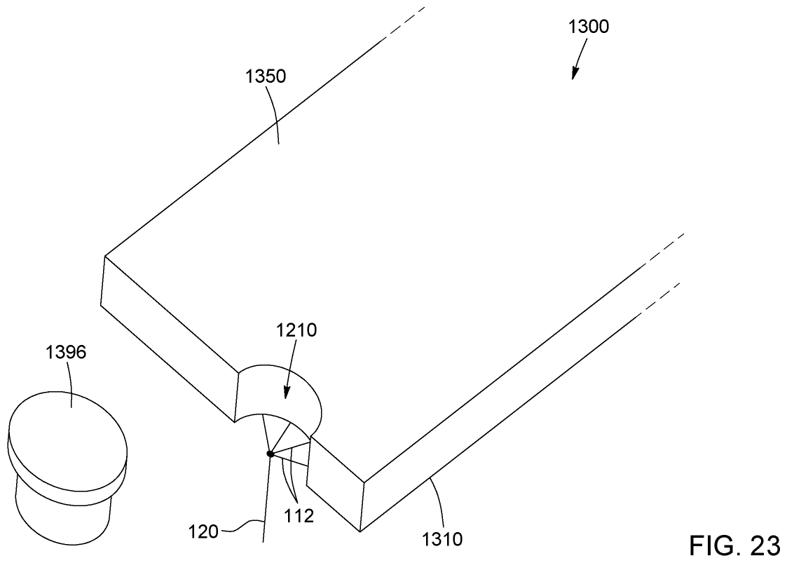

As represented in FIG. 23, the fastener-receiving openings 1210 might be formed in the heap-facing layer 1310 and an outer layer 1350 of the thermal insulation covering section 1300, so as to form a through opening therein. In the embodiment shown, the fastener-receiving opening 1210 is substantially cylindrical and extends along a longitudinal axis substantially perpendicular to the surfaces of the heap-facing layer 1310 and the outer layer 1350. The fastener-receiving opening could, in another embodiment, have a square cross-section or a cross-section of any other shape. As represented in FIG. 23, the fastener-receiving opening 1210 is designed fora fastener 120 to be introduced therethrough. In the embodiment shown, the fastener 120 is further secured via securing links 112 to one of the heap-facing layer 1310 and the outer layer 1350.

The thermal insulation covering section 1300 might further comprise an insulation cap 1396 receivable in the fastener-receiving opening 1210 and dimensioned to at least partially close the fastener-receiving opening 1210. The insulation cap 1396 might be engaged into the fastener-receiving opening 1210 to at least partially close it, to limit thermal exchanges between the insulated snow heap H and an outside of the thermal insulation assembly.

For instance, the thermal insulation covering 200 can have a substantially rectangular shape and can comprise two substantially parallel peripheral borders 202 located on or proximate the portion of the ground surface S supporting or surrounding the snow heap H. Any other shape of the thermal insulation covering 200 could be conceived, for the covering 200 to substantially conform to a shape of the insulated snow heap H.

In the embodiment shown, and as mentioned above, the thermal insulation covering 200 comprises a plurality of thermal insulation covering sections 300 configured in an adjacent configuration and assembled together, either directly or indirectly, articulately and/or pivotably connected to one another, in particular via the heap-mounting assembly 50. A person skilled in the art will easily adapt the number, the relative position and the dimensions of the plurality of thermal insulation covering sections 300 to adapt the dimensions and shape of the thermal insulation covering 200 to the dimensions and shape of the snow heap H to be insulated. Thermal insulation covering sections of different shapes and/or dimensions could be combined together to better mate the shape and dimensions of the snow heap to be covered (i.e. to better conform to the outer surface of the matter to be insulated).

It is appreciated that the shape, the configuration, and the location of the thermal insulation covering 200 with regards to the snow heap H, as well the configuration and the location the heap-mounting assembly comprising, for instance, the fasteners 120, the fastening links 110 and the retention straps 130, can vary from the embodiments shown.

Protective Layer

The heap-mounting assembly 50 of the thermal insulation assembly 100 might further comprise, as represented in FIG. 1, a protective layer 400 covering at least partially the thermal insulation covering 200 and extending on a portion of the outer surface 230 thereof. In some embodiments, the protective layer 400 form a structural membrane of the heap-mounting assembly.

In the embodiment shown, the protective layer 400 is at least partially made of a UV resistant material and/or a light-reflecting material. In some embodiments, the protective layer 400 might further comprise a water-tight film, located on a covering-facing surface 410, i.e. the surface of the protective layer 400 superposed to the thermal insulation covering 200, and/or on an outer surface 420 of the protective layer 400 and/or can at least partially be made of a water-tight material and/or a white material. In some embodiments, the protective layer 400 can be made of a material having one or more of the above-mentioned properties.

The protective layer 400 can be made a plurality of protective layer sections configured in an adjacent configuration and assembled together. The dimensions of the protective layer 400 can be smaller than the dimensions of the thermal insulation covering 200 (for instance substantially equal to the dimensions of one of the thermal insulation covering sections 300 of the thermal insulation covering 200), or can be equal to or greater than the dimensions of the thermal insulation covering 200, for instance to extend beyond the portion of the ground surface S and/or of the snow heap H covered by the thermal insulation covering 200. The protective layer 400 can also be made of a plurality of protective layers sections configured in an overlapping configuration (for instance in a shingle-like pattern) so as to form a drainage barrier (for instance against rain) over the thermal insulation covering 200.

The protective layer might further comprise vents (not represented) formed therein, for a fluid—such as air or vapor—to circulate through the protection layer. In an embodiment, the protective layer comprises air-circulation protrusions (not represented) formed on the covering facing surface of the protective layer. The air-circulation protrusions are designed to allow air—or any other fluid—circulation between the protective layer and the flexible thermal insulation covering. The combination of the vents and the air-circulation protrusions reduces thermal conduction between the external environment and the covered heap H. In another embodiment (not represented), air-circulation protrusions could be formed on an outer surface of the flexible thermal insulation covering.

The protective layer 400 could have water-absorbing properties for the protective layer 400 to absorb water (such as rain) and release it during hot times. The release of water could thus cool down the protective layer 400 to increase the insulation properties of the thermal insulation assembly 100.

It is appreciated that the shape, the configuration, and the location of the protective layer 400 with regards to the snow heap H, to the ground surface S and to the flexible snow heap thermal insulation covering 200 can vary from the embodiment shown.

Insulation Material

As described in detail below, as represented for instance in FIG. 4, in some embodiments, the thermal insulation covering sections 300 might define one or more insulation chambers 370, that are configured to be at least partially filled with an insulating material 140.

For instance, and without being limitative, the insulating material 140 is at least partially made of recycled insulation material, such as polystyrene, urethane, expanded polystyrene, expanded polyurethane, foamed plastic . . . .The insulating material 140 will be chosen for the filled thermal insulation covering 200 to be easily handled and should thus have a low density while being hardly compressible for the filled thermal insulation covering 200 not to be substantially flattened, for instance when an outer pressure is exerted thereon. Different materials having different insulation properties and/or flexibility properties can be used, such as and without being limitative, plastic material having a partially hollow structure, dried wood chips, dried sawdust, straw, . . . . The insulation material 140 could alternatively be made of non-recycled insulation material.

The granularity and/or the composition of the components of the insulation material 140 are determined based on the dimensions of the insulation chamber(s) 370 to be filled and/or on the weather conditions surrounding the insulated heap H. The insulation material 140 can for instance be made of one or more blocks of material having dimensions substantially equal to or slightly smaller than the dimensions of the insulation chamber 370 in which the insulation material 140 is inserted. For instance and without being limitative, the blocks of insulation material 140 can comprise recycled insulating material and/or non-recycled insulating material. In another embodiment, the insulating material 140 can be made of small pieces (such as seeds, chips . . . ) contained in a thermal insulation cushion or thermal insulation cushion (150) insertable into the insulation chamber 370. Moreover, the insulating material 140 might be chosen based on the material forming the heap H (i.e. based on the material to be insulated by the thermal insulation assembly 100). The insulating material 140 might further comprise a binding agent, configured to bind together granular elements of the insulating material 140. Moreover, blocks of insulating material 140 could be secured to each other, for instance via a flexible element, to provide some flexibility to the insulation chamber 370.

Thermal Insulation Covering Section

As mentioned above, the thermal insulation covering 200 comprises a plurality of thermal insulation covering sections 300 configured in the adjacent configuration and assembled together.

As detailed below, the term “adjacent” can refer to thermal insulation covering sections being at least partially superposed onto each other (i.e. thermal insulation covering sections configured in a partially overlapping configuration). The term “adjacent” can also refer to thermal insulation covering sections being spaced apart from each other and/or indirectly connected to each other, for instance via covering section couplers of the heap-mounting assembly 50.

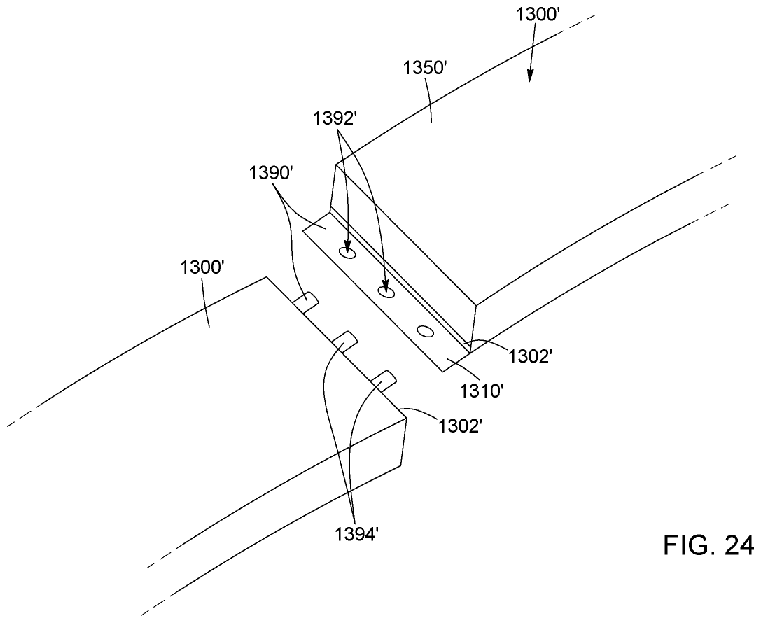

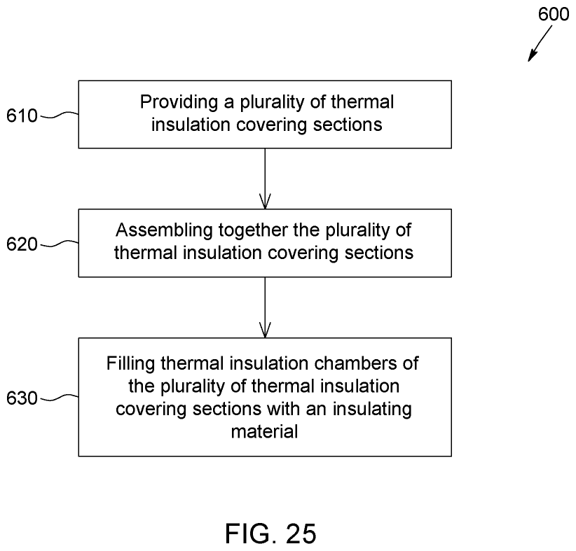

Moreover, it is understood that the adjacent thermal covering sections can either be directly assembled to each other (as represented in FIGS. 23 and 24), or indirectly assembled to each other, for instance via the covering section couplers or via any other element of the heap-mounting assembly 50.

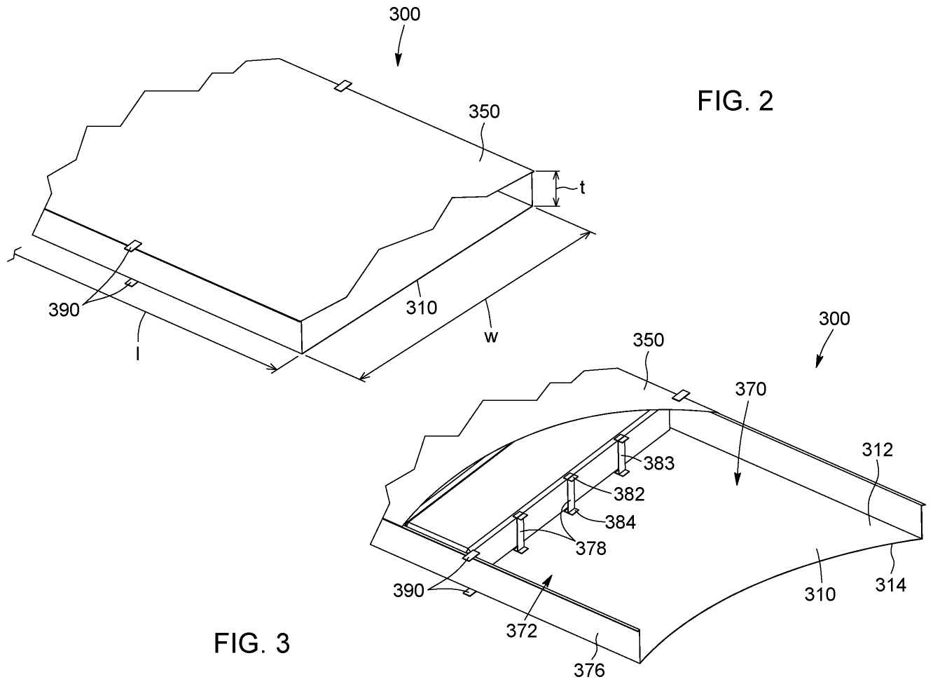

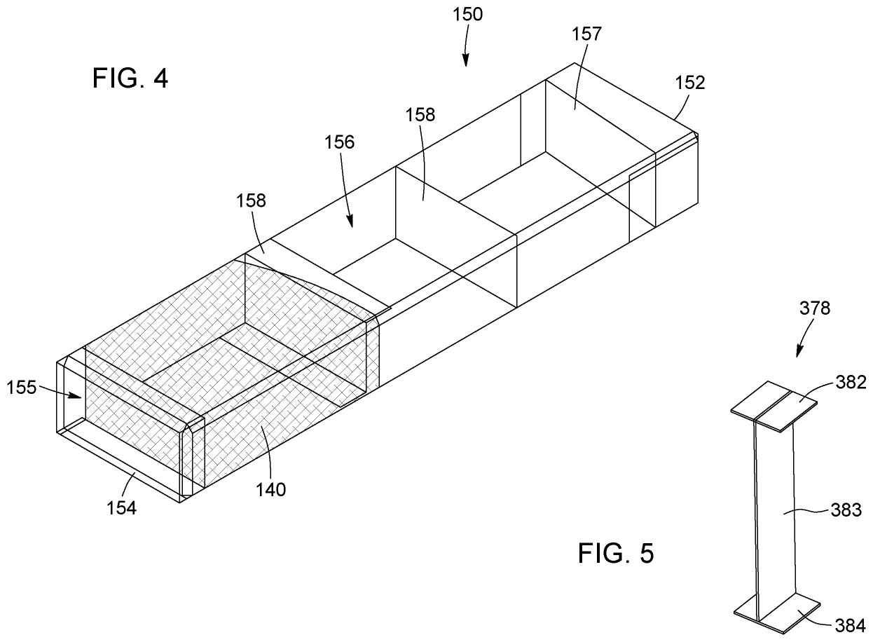

As represented for instance in FIGS. 2 and 3, the thermal insulation covering section 300 comprises the heap-facing layer 310 (or inner layer, considered with respect the snow heap H, or insulated matter-facing layer) and the opposed outer layer 350 at least partially secured to the heap-facing layer 310 and defining therewith at least one insulation chamber 370. It is thus understood that heap-facing surface 220 and the outer surface 230 of the thermal insulation covering 200 are respectively at least partially formed by the heap-facing layers 310 and the outer layers 350 of the plurality of thermal insulation covering sections 300 in the adjacent configuration.

In the embodiment shown, the thermal insulation covering section 200 includes one or more insulating material-filling opening 372, as represented for instance in FIG. 3. The insulating material-filling opening 372 is formed in one of the heap-facing layer 310 and the outer layer 350 or between the heap-facing layer 310 and the outer layer 350 or in a peripheral wall portion 376 (or peripheral border 376) of the insulation chamber 370 extending between the heap-facing layer 310 and the outer layer 350. It is understood that the heap-facing layer 310, the outer layer 350 and the peripheral wall portion 376 (or peripheral border of the thermal insulation covering section 300) at least partially delimit together the insulation chamber 370.

As represented in FIGS. 6A and 6B, in other embodiments of the thermal insulation covering sections 300′, 300″, the retention straps 130 extend along at least a portion of the thermal insulation covering section 300, 300″ and are secured (for instance sewed or fastened by any other suitable mechanical fastener) to at least one of the outer layer 350′, 350″ and the heap-facing layer 310′, 310″. At least some of the retention straps 130 are used to secure the thermal insulation covering 200 to the ground surface S and/or to the snow heap H.

In the embodiment shown, and as represented for instance in FIG. 2, the thermal insulation covering section 300 is substantially parallelepipedal in shape and comprises a length l, a width w and a height t.

In an embodiment, the length l is comprised between about 10 ft and about 100 ft. In another embodiment, the length l is comprised between about 20 ft and about 70 ft. In another embodiment, the length l is comprised between about 30 ft and about 60 ft. In yet another embodiment, the length l is comprised between about 45 ft and about 55 ft.

In an embodiment, the width w is comprised between about 1 ft and about 30 ft. In another embodiment, the length l is comprised between about 5 ft and about 20 ft. In yet another embodiment, the length l is comprised between 7 ft and about 10 ft.

In an embodiment, the height t is comprised between about 0.5 inch and about 30 inches. In another embodiment, the height t is comprised between about 1 inch and about 15 inches. In yet another embodiment, the height t is comprised between about 5 inches and about 14 inches. In some embodiments, the thermal insulation covering section 300 has a length l comprised between about 8 ft and about 15 ft, a width w comprised between 5 ft and about 10 ft, and a height t comprised between about 0.5 inch and about 2 inches.

In an embodiment, the thermal insulation covering 200 is designed to cover a snow heap H greater than about 1 000 000 m³ and comprises more than about 1500 thermal insulation covering sections 300 (for instance having a length l comprised between about 40 ft and about 50 ft, and a width w comprised between about 5 ft and about 20 ft). In another embodiment, the thermal insulation covering 200 is designed to cover a snow heap H greater than about 20 000 m³ and comprises more than about 100 thermal insulation covering sections 300. In another embodiment, the thermal insulation covering 200 is designed to cover a snow heap H greater than about 2 000 m³ and comprises more than about 25 thermal insulation covering sections 300.

It is understood that the thermal insulation covering section 300 can have different shapes and/or dimensions. Moreover, thermal insulation covering sections 300 can be assembled together in a substantially overlapping configuration, so as to form a corner of the thermal insulation covering 200 in which deformations of the insulated heap H are expected. The arrangement of overlapping adjacent insulation covering sections 300 thus insulates the covered snow heap H while allowing some displacement of the thermal insulation covering 200 with regards to the snow heap H.

Insulated Matter-Facing Layer/Heap-Facing Layer

The heap-facing layer 310 is at least partially made of a water resistant and/or flexible and/or rollable material. For instance and without being limitative, the heap-facing layer 310 of the thermal insulation covering section 300 comprises a sheet of thermoplastic or coated textiles, at least partially made, for instance, of polyurethane, TPO (Thermo Plastic Olefin), PVC (Polyvinyl chloride), EPDM (ethylene propylene diene monomer), polyurethanes, composite high-strength extrusion-coated textile, tear-resistant PTFE, coated fiberglass fabric sheet, or a superposition of sheets of similar or different materials. The heap-facing layer 310 can comprise a continuous or discontinuous (for instance perforated or meshed) sheet or a plurality of continuous and/or discontinuous sheets

The thermal insulation covering section 300 might further comprise stiffeners (or structural reinforcers or covering stiffener) for instance embedded into the heap-facing layer 310 or located in a stiffener-receiving sleeve (or stiffener-receiving pocket) formed by a folded portion of the heap-facing layer 310 or extending on one of an outer face 312 and/or an inner face 314 (or heap-facing face 314) of the heap-facing layer 310 (FIG. 3). The stiffener-receiving sleeve might also be formed by a portion of the outer layer 350, or by a combination of portions of the outer layer 350 and the heap-facing layer 310. The stiffeners might also be located in a sleeve formed between two portions of the heap-facing layer 310 and the outer layer 350 secured to each other. The stiffeners might be secured (for instance glued or welded or fastened by any suitable mechanical fastener) to the outer face 312 and/or the inner face 314 (or heap-facing face 314) of the heap-facing layer 310.

The stiffeners comprise for instance a reinforcing strap, a wire, a chain—for instance made of steel—or sections of straps and/or wires and/or chains assembled together and secured to the outer face 312 and/or the inner face 314 of the heap-facing layer 310. The heap-facing layer 310 might also be at least partially made of a material having inner stiffeners (for instance made of reinforced plastics comprising glass fiber embedded therein or having a polyester mesh embedded therein) or of a combination of a plurality of plastic sheets.

In some embodiments, the heap-facing layer 310 is thus designed to be moved on the ground surface S and/or to be pulled—for instance by the above-mentioned fastening links 110—without being torn.

It is appreciated that the shape and the construction of the heap-facing layer 310 can vary from the embodiments shown. It is also appreciated that the shape, the configuration, and the location of the stiffeners with regards to the covering section 300 and to the heap-facing layer 310 can vary from the embodiments shown. It is understood that the stiffeners can also be used to contribute to the securing of the thermal insulation covering 200 on the snow heap H.

It should be understood that the present disclosure is not limited to thermal insulation covering sections wherein the heap-facing layer would be directly in contact with the snow heap H: the heap-facing layer could be separated therefrom by a protective layer, an insulating membrane, or any other element.

Outer Layer

The outer layer 350 is at least partially made of a light repulsive and/or flexible and/or rollable material. For instance and without being limitative, the outer layer 350 comprises a sheet of plastic, at least partially made, for instance, of polyurethane, TPO, PVC, . . . . For instance, the outer layer 350 can be made of the same material as the one forming the heap-facing layer 310. In an embodiment, the outer layer 350 and the heap-facing layer 310 are at least partially made of polymers of a same family or classification, for the layers 310, 350 to be easily bonded together (for instance by being welded at least partially to each other).

In the embodiment shown, the outer layer 350 and the heap-facing layer 310 are secured together by being bonded, glued, thermally welded, seamed or by any other suitable mechanical fastener or adhesive.

The outer layer 350 might comprise a peripheral border, forming an overlapping portion (or flap—for instance formed by a folded portion of the peripheral border, secured or sewed to itself). The overlapping portion of the peripheral border might thus at least partially overlap an adjacent thermal insulation covering section 300 when assembled therewith to form the flexible snow heap thermal insulation covering 200.

It is appreciated that the shape and the construction of the outer layer 350 can vary from the embodiment shown.

Insulation Chamber

As represented in FIG. 3, the peripheral wall portion 376 of the insulation chamber 370 is at least partially formed by a portion of the heap-facing layer 310. In another embodiment (not represented), the peripheral wall portions of the insulation chambers could be at least partially formed by a portion of the outer layer.

As represented in FIG. 6B, the peripheral wall portions 376″ extending between adjacent insulation chambers 370″ are at least partially made by outwardly folded portions of the heap-facing layer 310″. The thermal insulation covering section 300″ might further comprise layer connectors 374″ (comprising for instance and without being limitative welding areas) to engage portions of the heap-facing layer 310″ with the outer layer 350″ so as to secure an outer end of the peripheral wall portion 376″ formed by the heap-facing layer 310″ to the outer layer 350″. In the embodiment shown, retention straps 130 are secured to the outer layer 350″ and the heap-facing layer 310″ at or proximate to some of the layer connectors 374.

In another embodiment (not represented), the peripheral wall portion might be at least partially formed by an inwardly folded portion of the outer layer, or by a combination or a superposition of folded portions of the heap-facing layer and the outer layer, with layer connectors—comprising for instance and without being limitative welding areas—connecting together the different portions of the outer and heap-facing layers, so as to form at least one insulation chamber.

In another embodiment, as represented in FIG. 6A, the peripheral wall portions 376′ extending between adjacent insulation chambers 370′ are formed by cut portions of one of the outer layer 350′ and/or the heap-facing layer 310′. Layer connectors 374′—comprising for instance and without being limitative welding areas—are arranged between the peripheral wall portions 376′ and the corresponding portions of the outer layer 350′ and the inner layer 310′ to form the different insulation chambers 370′. Retention straps 130 might further extend at a junction between the peripheral wall portions 376′ and the outer and heap-facing layers 350′, 310′.

In the embodiment shown in FIGS. 2 and 3, the insulation chamber 370 extends at least partially along the width w of the thermal insulation covering section 300. In an embodiment, the insulation chamber 370 extends at least along 50% of the width w. In another embodiment, the insulation chamber 370 extends at least along 80% of the width w. In yet another embodiment, the insulation chamber 370 extends substantially along an entirety of the width w.

As represented in FIGS. 2, 3 and 5, the thermal insulation covering section 300 might further comprise one or more internal stiffeners 378 (or inter-layers stiffeners or covering stiffeners 378) arranged within the insulation chamber 370 or between two adjacent insulation chambers 370 and to at least partially maintain the heap-facing layer 310 and the outer layer 350 spaced apart from each other, for the insulating material 140 to be easily introduced in the insulation chambers 370 formed therebetween. Moreover, the internal stiffeners 378 (or covering stiffeners 378) are also designed to prevent the insulating material 140 once introduced in the insulation chambers 370 to be excessively compacted as well as to prevent the heap-facing layer 310 and the outer layer 350 from being separated from each other, for instance while the insulating material 140 is being introduced into the insulation chambers 370 or while the covering section 300 is used, for instance for a significant period of time.

For instance, the internal stiffeners 378 (or covering stiffeners 378) extend substantially parallel to each other. In the embodiment shown, adjacent internal stiffeners 378 are arranged within the thermal insulation chamber 370 partially along the width w of the thermal insulation covering section 300. In an embodiment, the plurality of internal stiffeners 378 extend substantially along the entirety of the width w of the thermal insulation covering section 300. For instance, the plurality of internal stiffeners 378 are regularly spaced-apart from each other. In the embodiment shown, the internal stiffeners 378 extend within the thermal insulation chamber 370 between the heap-facing layer 310 and the outer layer 350. The internal stiffeners 378 have outer and inner engaging ends 382, 384 (or outer and inner layer-engaging end 382, 384) engaged respectively with the outer layer 350 and to the heap-facing layer 310, for instance by being bonded to them (for instance by being glued, thermally welded, radio frequency welded or seamed to them) and a stiffening body 383 extending between the outer and inner engaging ends 382, 384. The internal stiffeners 378 can be made of steel, of rope, of strap or of a portion of one of the outer layer 350 and the heap-facing layer 310 or of a combination thereof. Depending on their location with regards to the outer layer 350 and the heap-facing layer 310, the internal stiffeners 378 can be designed to resist compression forces (for instance to allow a user to walk on the thermal insulation covering 200) and could thus for instance and without being limitative have a length substantially greater than the height h of the thermal insulation covering section 300 and/or made of a compression resistant material, such as rigid plastics)—or designed to resist elongation forces—and could thus for instance and without being limitative have a length substantially smaller than the height h of the thermal insulation covering section 300. Any other suitable mechanical fastener can be used to secure the internal stiffeners 378 to the outer layer 350 and the heap-facing layer 310, either to internal or external surfaces thereof. For instance, the covering stiffeners 378 are connectable to the heap-mounting assembly 50 so as to increase the securing of the thermal insulation covering 200.

As represented in FIG. 6B, the internal stiffeners 378″ might be at least partially formed by the heap-facing layer 310″. A covering section in which the internal stiffeners would be formed at least partially by the outer layer or by a combination of the heap-facing layer and the outer layer could also be conceived.

The covering section 300 (for instance the heap-facing layer 310 and/or the outer layer 350 thereof) might also at least partially be made of a film made of an air-tight and/or water-tight material. The film can at least partially surround one or more insulation chambers 370. It is thus understood that the insulation chamber 370 can have an inner pressure smaller than or substantially equal to the pressure of the external environment. In other words, the insulation chamber 370 can be under partial vacuum, or the film can allow air to circulate in and out.

Moreover, the insulation chamber 370 at least partially defined by the thermal insulation covering section 300 can be configured to receive directly the insulating material 140 or to receive one or more thermal insulation bricks 150 (or thermal insulation cushions 150) filled with the insulating material 140, as represented in FIG. 3. Moreover, the insulating material 140 and/or the thermal insulation cushions 150 can also be arranged within the insulation chamber 370 while manufacturing the covering section 300 and before hermetically closing the insulation chamber 370. In other words, the covering section 300 might not comprise any insulating material-filling opening. In some embodiments, the insulation chamber 370 might not be hermetically closed. In some embodiments, the thermal insulation covering section 300 might be formed in breathable material.

In the embodiment represented in FIG. 4, the thermal insulation cushion 150 is substantially parallelepipedal in shape. The thermal insulation cushion 150 has first and second opposed longitudinal ends 152, 154 with an insulating material-filling opening 155 formed for instance at one of the ends. At least one insulating material-receiving chamber 156 is formed in the thermal insulation cushion 150. In the embodiment shown, the thermal insulation cushion 150 further comprises inner wall portions 158 (or cushion-stiffening members 158 or brick-stiffening members), for instance made of cardboard or any other material having rigidity properties, extending for instance substantially parallel to each other and defining a plurality of insulating material-receiving chambers 156. The thermal insulation cushion 150 comprises an outer layer 157 delimiting outwardly the insulating material-receiving chambers 156. For instance, the outer layer 157 is at least partially formed of an air-tight and/or water-tight material, or of any other suitable material.

The insulation chamber 370 and the insulating material-filling opening 372 can be shaped and dimensioned to receive one or more thermal insulation cushions 150, for the insulating material 140 to at least partially fill the insulation chamber 370. For example and without being limitative, as represented in FIG. 3, a plurality of thermal insulation cushions 150 are received in the insulation chamber 370, for instance extending substantially parallel to each other along at least a portion of the width w of the thermal insulation covering section 300. In the embodiment shown, each of the thermal insulation cushions 150 extends substantially along an entirety of the width w of the thermal insulation covering section 300.

It is understood that the insulating material 140 can comprise a material having rigidity properties configured to replace all or parts of the inner wall portions 158 (or cushion-stiffening members 158) of the thermal insulation cushions 150. The insulating material 140, inserted into the insulation chamber 370 either directly or via the thermal insulation cushions 150, can also comprise a material having rigidity properties configured to replace all or part of the covering stiffeners 378 of the thermal insulation covering section 300.

It is appreciated that the shape, the configuration, and the location of the insulation chamber with regards to the thermal insulation covering section 300 can vary from the embodiment shown. Moreover, the shape, the configuration, the construction and the location of the covering stiffeners 378 and the insulating material-filling opening 372 with regards to the insulation chamber might vary from the embodiment shown.

Moreover, the shape, the configuration, the construction and the location of the thermal insulation cushions 150 (or thermal insulation bricks 150) with regards to the insulation chamber can vary from the embodiment shown.

It is in particular understood that the present disclosure is not limited to thermal insulation cushions being substantially parallelepipedal in shape and/or having rigidity properties. Moreover, the thermal insulation cushion can either be formed in an air-tight material (for instance so as to allow creating vacuum therein) or in an air-permeable material.

Structural and Insulating Membranes

In the embodiment represented in FIGS. 2 and 3, one of the heap-facing layers 310 and the outer layers 350 of the plurality of adjacent thermal insulation covering sections 300 can be designed to form a structural membrane of the flexible snow heap thermal insulation covering 200, whereas the other one of the heap-facing layers 310 and the outer layers 350 of the plurality of adjacent thermal insulation covering sections 300 can be designed to form an insulating membrane of the flexible snow heap thermal insulation covering 200. It is also understood that one of the heap-facing layers 310 and the outer layers 350 of the plurality of adjacent thermal insulation covering sections 300 or a combination of the heap-facing layers 310 and the outer layers 350 of the plurality of adjacent thermal insulation covering sections 300 could be designed to form both the structural membrane and the insulating membrane.

The structural membrane is designed to contribute to the mechanical resistance of the thermal insulation covering 200 and to allow transmission of mechanical forces of the thermal insulation covering 200 to the fasteners 120 and the fastening links 110 (or covering section-fastening links 110). The structural membrane is formed in a material having low deformation properties. In the embodiment shown, the structural membrane has a deformation coefficient smaller than about 1%. The structural membrane might have fire-retardant properties. In some embodiments, in particular when the insulated material-mounting assembly comprises other components (such as ground fasteners, covering section-fastening links, . . . ), the membrane might not necessarily have low deformation properties (i.e. might not necessarily be structural).

The insulating membrane is configured to at least partially form the insulation chambers 370 receiving the insulating material 140. The insulation membrane is formed in a material acting as an air barrier and/or a water barrier and/or a vapor barrier. The insulating membrane might have fire-retardant properties.

It is appreciated that the construction of the structural membrane and the insulating membrane can vary from the embodiment shown.

Covering Section Connectors

As represented in FIGS. 2 and 3, the thermal insulation covering section 300 couple comprise one or more covering section connectors 390, for instance engageable with and/or securable to the heap-mounting assembly. In the embodiment shown, the covering section connectors 390 protrude outwardly from the thermal insulation chamber 370, for instance outwardly from the heap-facing layer 310, from the outer layer 350, from the peripheral wall portion 376 or from at junction between the peripheral wall portion 376 and the heap-facing layer 310 and/or the outer layer 350. The covering section connectors 390 might be configured to cooperate with the section connectors 390 of an adjacent insulation covering section 300, to the above-mentioned fastening links 110 and/or to the protective layer 400 and/or to any other component of the heap-mounting assembly 50. The covering section connectors 390 might be located at a junction between two adjacent thermal insulation chambers 370. The covering section connectors 390 might be shaped and dimensioned to assemble together (or to secure together) adjacent thermal insulation covering sections 300.

In the embodiment represented in FIG. 24, the thermal insulation covering section 1300′ comprises one or more covering section connectors 1390′ at a peripheral border 1302′ thereof, to assemble together (or secure together) thermal insulation covering sections 1300′ configured in the adjacent configuration.

In the embodiment shown, the covering section connectors 1390′ comprise eyelets 1392′ formed in at least one of the heap-facing layer 1310′ and the outer layer 1350′, and connecting straps 1394′ extending from the peripheral border 1302′ of the adjacent thermal insulation covering section 1300′. The connecting straps 1394′ are receivable into the eyelets 1392′ to assemble (or secure together) the adjacent thermal insulation covering sections 1300′.

Referring back to FIGS. 2 and 3, the heap-facing layer 310 and the outer layer 350 might be removably secured to each other (for instance via a hook and loop fastener, a zipper or any other suitable removably mechanical fastener), for the heap-facing layer 310 and the outer layer 350 to be easily at least partially detachable from each other, for instance along a portion of the length l of the thermal insulation covering section 300, so as to form the insulating material-filling opening 372 therebetween. As mentioned above, it could also be conceived thermal insulation covering section comprising no insulating material-filling opening (i.e. in which the heap-facing layer, the outer layer and/or the peripheral wall portion would be permanently and/or hermetically secured to each other).

It is appreciated that the shape, the configuration, and the location of the covering section connectors 390 can vary from the embodiments shown.

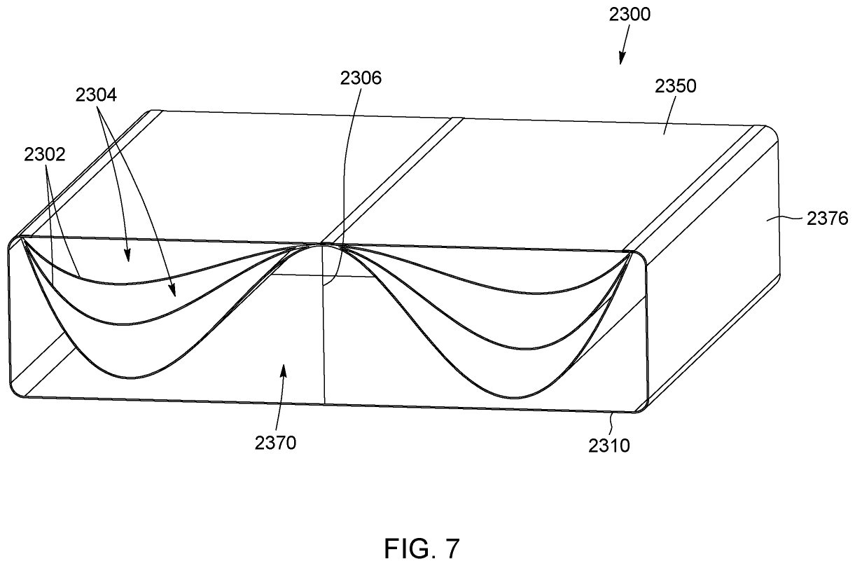

As represented in FIG. 7, in another embodiment, the thermal insulation covering section 2300 can be at least partially inflatable. In the embodiment shown, the thermal insulation covering section 2300 comprises a plurality of inner air-tight foils 2302 extending in the thermal insulation chamber 2370 and defining therein one or more inflatable chamber sections 2304. For instance, the inner air-tight foils 2302 are secured (for instance welded, sewn or heat-sealed) to at least one of the heap-facing layer 2310, the outer layer 2350 and the peripheral wall portion 2376. For instance, the inner air-tight foils 2302 are at least partially made of Mylar™ or any other flexible air-tight material. It is understood that the inner air-tight foils may be perforated and/or at least partially be made in a breathing material in order to allow some air circulation between the insulation chambers 2370, for instance to substantially equalize pressures in the different insulation chambers 2370.

In the embodiment shown, the inflatable chamber sections 2304 extend along at least a portion of the length of the thermal insulation covering section 2300, but they could also extend, for instance, along the width thereof.

In the embodiment shown, the thermal insulation covering section 2300 also comprises an inflation-limiting member 2306 extending in the thermal insulation chamber 2370 and configured for instance to limit the separation distance between the heap-facing layer 2310 and the outer layer 2350 upon inflation of at least one of the inflatable chamber sections 2304.

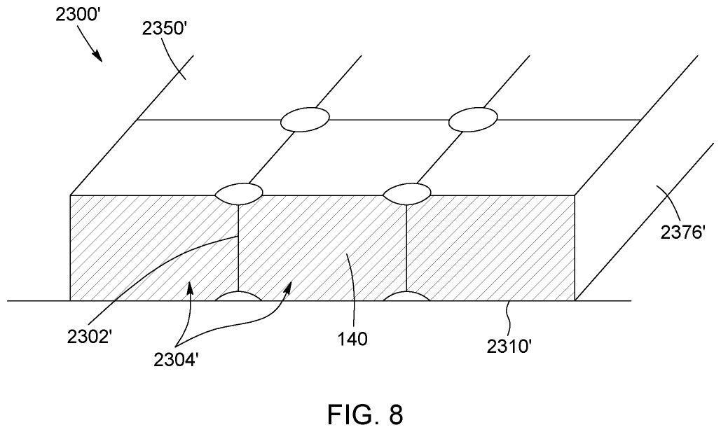

In another embodiment, as represented in FIG. 8, the insulating material 140 can also fill at least partially some of the inflatable chamber sections 2304′ at least partially delimited by the inner air-tight foils 2302′ secured to at least one of the outer layer 2350′, the heap-facing layer 2310′ and the peripheral wall portion 2376′ extending between the outer layer and the heap-facing layer.

It is understood that the present disclosure is not limited to thermal insulation covering sections that would be inflatable at least partially via inflatable chamber sections formed within the thermal insulation chamber. In another embodiment, the thermal insulation chamber of the thermal insulation covering section could receive one or more thermal insulation bricks (or thermal insulation cushions) that would be at least partially inflatable. The thermal insulation covering section could also comprise a combination of inflatable chamber sections formed within the thermal insulation chamber and of inflatable thermal insulation cushions arranged within the thermal insulation chamber.

It is appreciated that the shape, the configuration, and the location of the inflatable chamber sections, the inner air-tight foils and the inflation-limiting member can vary from the embodiments shown.

### Other Embodiments of the Flexible Thermal Insulation Assembly

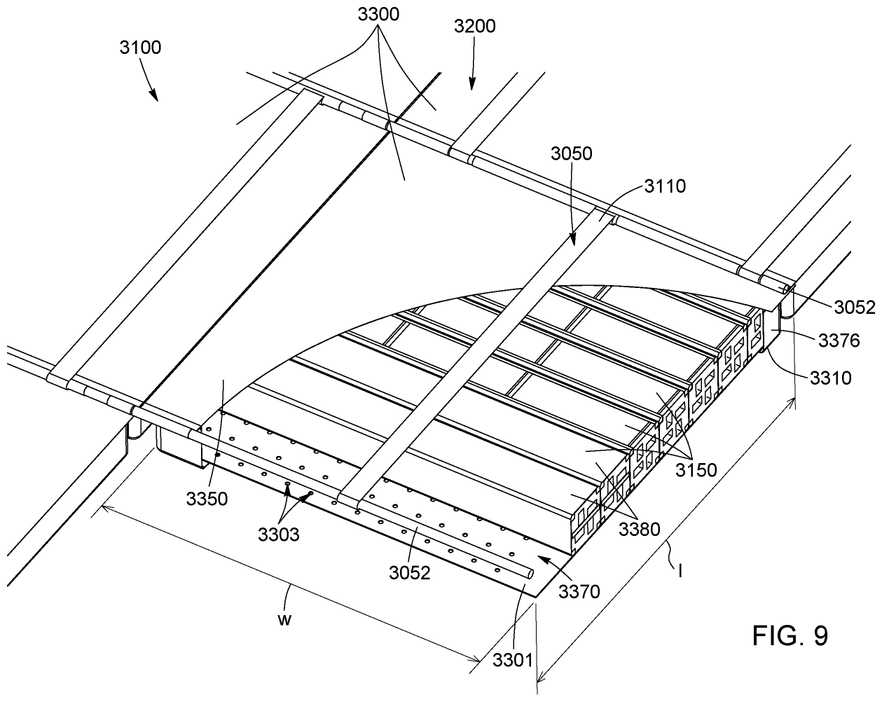

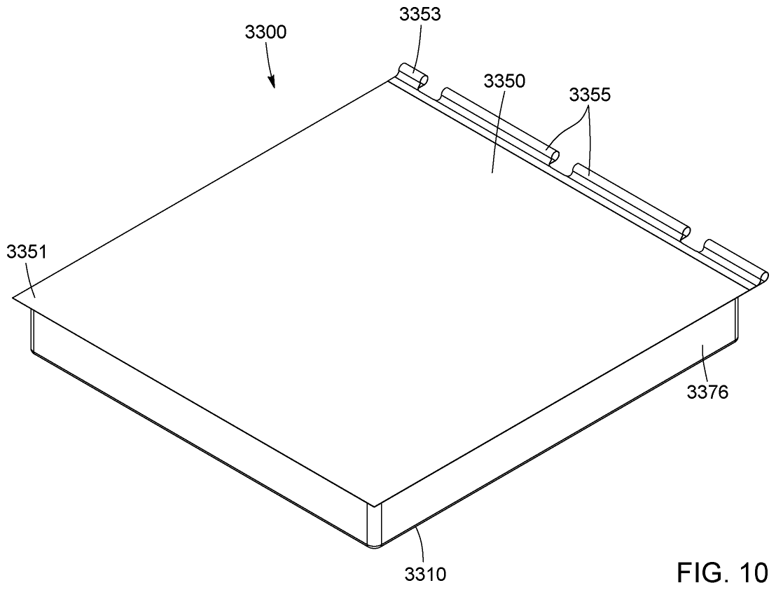

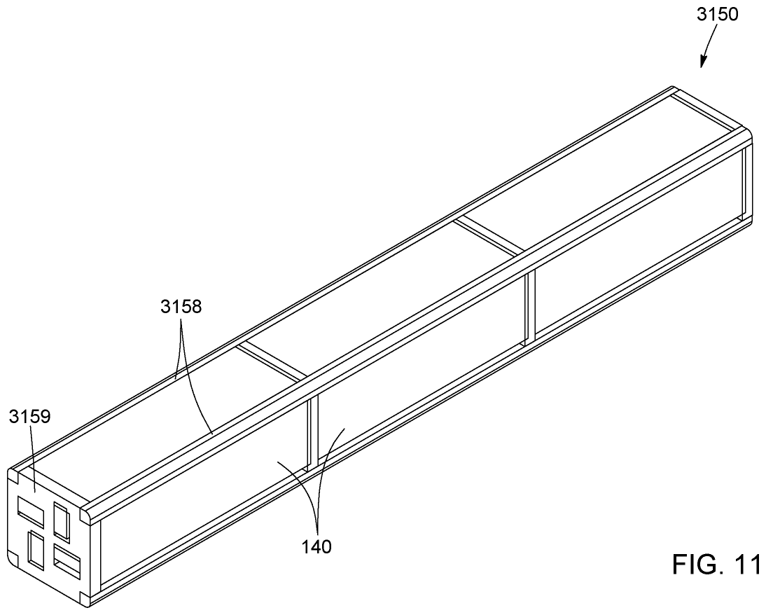

FIGS. 9 and 10 represent another possible embodiment of a thermal insulation assembly 3100 comprising a plurality of thermal insulation covering sections 3300 comprising a heap-facing layer 3310, an outer layer 3350 and a peripheral border 3376 extending therebetween and at least partially delimiting therewith a thermal insulation chamber 3370.

In the embodiment shown, the outer layer 3350 forms a covering section flap 3351 having dimensions (for instance a width and a length) greater than dimensions of the thermal insulation chamber 3370. The covering section flap 3351 is thus configured to form an overlapping portion at least partially covering an adjacent thermal insulation covering section 3300, as represented in FIG. 9, so as to increase the sealing of the thermal insulation covering 3200 formed by the combination of the adjacent thermal insulation covering sections 3300 in the adjacent configuration (i.e. to improve the water-tight assembly formed by the combination of the thermal insulation covering sections 3300). Moreover, as represented in FIGS. 9 and 10, the outer layer 3350 comprises a covering section-assembling portion 3353, for instance formed at an end portion thereof. In the embodiment shown, the covering section-assembling portion 3353 comprises a plurality of assembling members 3355 spaced from each other and extending together along at least a portion of the width of the thermal insulation covering section 3300. In the embodiment shown, the assembling members 3355 comprise rod-receiving sleeves configured to receive a covering section coupler 3052 (for instance a covering section-coupling rod 3052) of the heap-mounting assembly 3050. Moreover, the heap-mounting assembly 3050 further comprises covering section-fastening links 3110 (such as covering section-fastening straps 3110) configured to link together (or to connect together, or to secure together) covering section couplers 3052 of adjacent thermal insulation covering sections 3300 for them to be assembled together.

As represented in FIG. 9, the thermal insulation covering section 3300 further comprises an insulating panel 3301 extending—or contained—in the thermal insulation chamber 3370, for instance facing the heap-facing layer 3310 (i.e. an inner face thereof, considered with respect to the thermal insulation chamber). For instance, the insulating panel 3301 has dimensions corresponding substantially to the dimensions of the thermal insulation chamber 3370. In the embodiment shown, water-circulating apertures 3303 are formed in the insulating panel 3301. The insulating panel 3301 thus forms a bottom panel covering at least partially a bottom surface of the thermal insulation chamber 3370 so as to limit the formation of condensation within the thermal insulation chamber 3370.

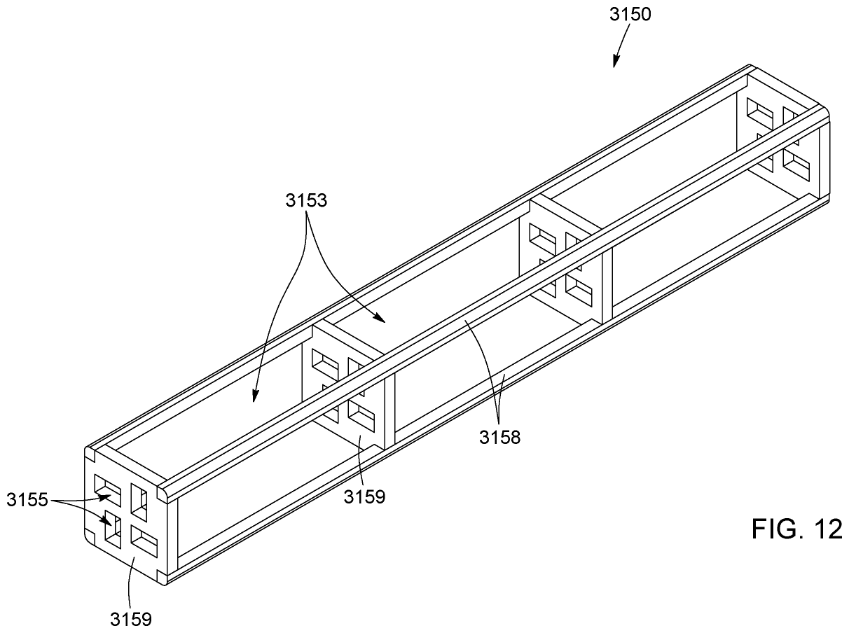

As represented in FIG. 9, a plurality of thermal insulation cushions 3150 are arranged—i.e. at least partially contained—within the thermal insulation chamber 3370. For instance, the thermal insulation cushion 3150 has a height comprised between about 1 inch and about 20 inches (for instance comprised between about 10 inches and about 15 inches), a width comprised between about 1 inch and about 20 inches (for instance comprised between about 10 inches and about 15 inches) and a length comprised between about 5 feet and about 15 feet (for instance of the order of 8 feet). Some of the thermal insulation cushions 3150 are at least partially surrounded by an air-tight and/or water-tight film 3380. In the embodiment shown, the thermal insulation cushions 3150 extend along substantially an entirety of the width w of the thermal insulation covering section 3300 and are substantially parallelepipedal in shape. In the embodiment shown, as represented in FIGS. 11 and 12, the thermal insulation cushion 3150 comprises cushion-stiffening members 3158, 3159. More particularly, the thermal insulation cushion 3150 comprises longitudinal cushion-stiffening members 3158 (four, in the embodiment shown, extending along a length of the thermal insulation cushion 3150 at corners thereof) and transversal cushion-stiffening members 3159 (four, in the embodiment shown) defining therebetween insulating material-receiving chambers 3153 (three, in the embodiment shown). Insulating material-injecting openings 3155 are formed in the transversal cushion-stiffening members 3159 (or inner wall portions 3159) so as to inject the insulating material 140 within at least some of the insulating material-receiving chambers 3153.

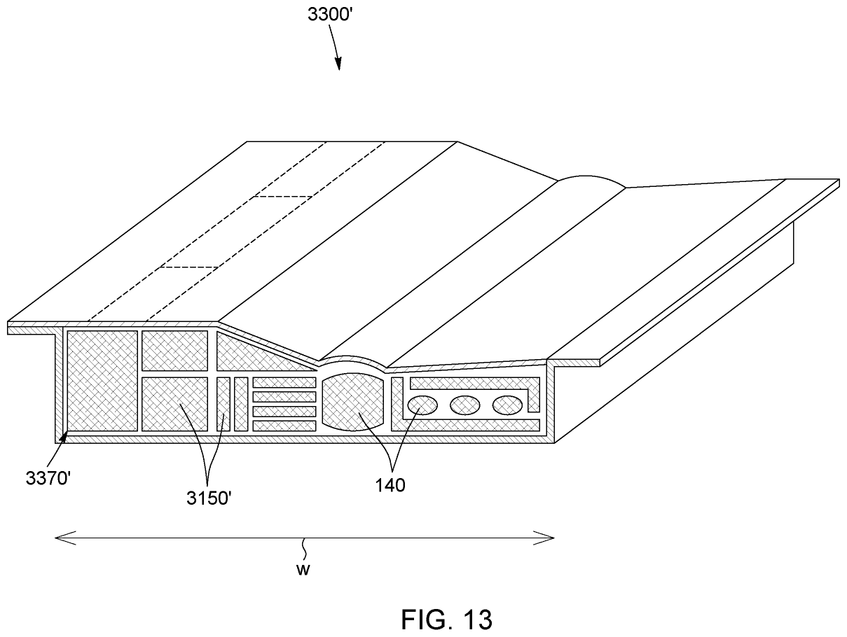

In the embodiment shown, the thermal insulation cushions 3150 are substantially identical in shape and dimensions. However, as represented in FIG. 13, it could be conceived a thermal insulation covering section 3300′ having a thermal insulation chamber 3370 that would be shaped and dimensioned to receive thermal insulation cushions 3150′ of different shapes and/or dimensions. The thermal insulation chamber could also receive a combination of thermal insulation cushions and insulating material directly introduced therein (i.e. not contained in a thermal insulation cushion). It could also be conceived a thermal insulation covering section with a plurality of thermal insulation chambers formed therein, having for instance different shapes and/or dimensions and/or constructions. For instance, the different thermal insulation chambers of the thermal insulation covering section might have different lengths, considered along the width w of the thermal insulation covering section, have different dimensions and/or shapes, be filled with different insulating materials. The thermal insulation covering section might also comprise a plurality of thermal insulation chambers superposed onto each other in different directions.

FIG. 14 represents another possible embodiment of a plurality of thermal insulation covering sections 4300 forming together a thermal insulation covering 4200 of a thermal insulation assembly 4100. In the embodiment shown, the thermal insulation covering sections 4300 form together a plurality of covering section rows 4301 separated from each other by covering section couplers 4052 of the heap-mounting assembly 4050.

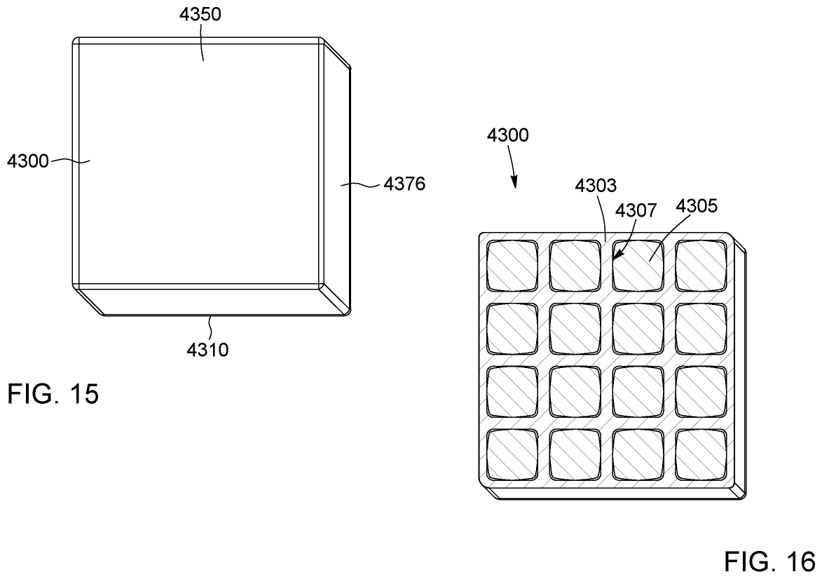

In the embodiment shown, as represented in FIGS. 15 and 16, the thermal insulation covering section 4300 has a heap-facing layer 4310 and an outer layer 4350 extending substantially parallel to each other. Moreover, in the embodiment shown, the heap-facing and outer layers 4310, 4350 are offset with respect to each other so that the peripheral border 4376 extends in a non-perpendicular direction with respect to any of the heap-facing layer 4310 and the outer layer 4350. In the embodiment shown, the thermal insulation covering section 4300 has a length and a width comprised between about 2 feet and about 10 feet, for instance comprised between about 4 feet and about 8 feet. In the embodiment shown, the thermal insulation covering section 4300 has a height h comprised between about 2 inches and about 30 inches, for instance comprised between about 6 inches and about 18 inches.

Moreover, in the embodiment shown, the thermal insulation covering section 4300 comprises an inner reinforcing grid 4303 (or stiffening matrix 4303 or reinforcing inner matrix 4303) and a thermal insulation body 4305 made for instance at least partially by an insulating material (for instance and without being limitative polystyrene or any other, either new or recycled, insulating material). The inner reinforcing grid 4303 extends at least partially within the thermal insulation body 4305 (is for instance at least partially embedded therein, for instance during the manufacturing of the thermal insulation covering section 4300). For instance, the inner reinforcing grid 4303 extends in a plane substantially parallel to the heap-facing layer 4310 and/or the outer layer 4350. For instance, insulating material-receiving apertures 4307 are formed in the inner reinforcing grid 4303, insulating material being injected in the insulating material-receiving apertures.

In the embodiment shown, the inner reinforcing grid 4303 extends along at least a portion of the height h of the thermal insulation body 4305. In some other embodiments, the inner reinforcing grid 4303 extends along at least about 20% of the height h of the thermal insulation body 4305. In some other embodiments, the inner reinforcing grid 4303 extends along at least about 40% of the height h of the thermal insulation body 4305. In some other embodiments, the inner reinforcing grid 4303 extends along at least about 60% of the height h of the thermal insulation body 4305. In some other embodiments, the inner reinforcing grid 4303 extends along at least about 80% of the height h of the thermal insulation body 4305. In yet some other embodiments, the inner reinforcing grid 4303 extends along substantially an entirety of the height h of the thermal insulation body 4305.

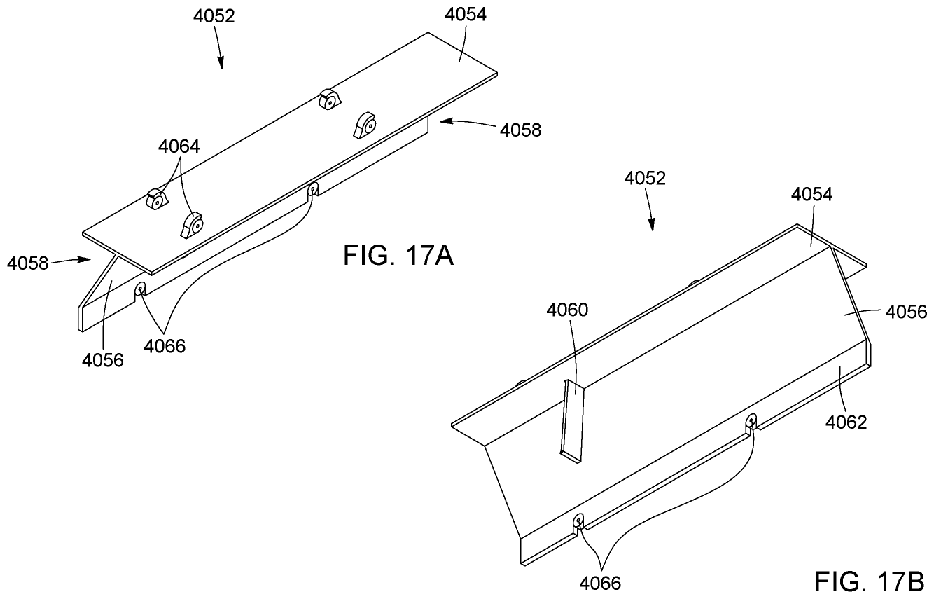

FIGS. 17A and 17B represent a possible embodiment of the covering section coupler 4052 (for instance made of plastics, wood, steel, or any other material having rigidity properties). As represented in FIG. 14, the covering section couplers 4052 are shaped and dimensioned to extend at least partially between adjacent ones of the plurality of thermal insulation covering sections 4300 and to provide a flexible interconnexion therebetween. In the embodiment shown, the covering section coupler 4052 comprises a cable-guiding portion 4054 (or upper portion 4054, or cable-guiding plate 4054), shaped and dimensioned to at least partially cover adjacent thermal insulation covering sections 4300 when arranged therebetween. The covering section coupler 4052 further comprises a covering section-separating plate 4056 extending downwardly from the cable-guiding plate 4054 (for instance transversally, not necessarily perpendicularly, to the cable-guiding plate 4054) and defining therewith two opposed covering section-receiving portions 4058. The covering section-receiving portions 4058 are shaped and dimensioned to receive at least partially adjacent thermal insulation covering sections 4300 when the covering section coupler 4052 is arranged therebetween. In other words, in the embodiment shown, the covering section coupler 4052 has a substantially T-shaped cross-section. In the embodiment shown, the covering section coupler 4052 further comprises a covering section-separating tab 4060 extending downwardly from the cable-guiding plate 4054 and configured to extend between adjacent thermal insulation covering sections 4300 of a same covering section row 4301. The covering section coupler 4052 could also comprise a covering section-separating tab extending on the other side of the covering section-separating plate 4056 so as to form four covering section-receiving portions 4058.

In the embodiment shown, the covering section coupler 4052 further comprises a snow heap-engaging base 4062 (or insulated matter-engaging base 4062), for instance extending downwardly from the covering section-separating plate 4056. The snow-heap engaging base 4062 is shaped and dimensioned to be at least partially engaged with the snow heap H so as to increase the assembling of the thermal insulation covering 4200 formed by the plurality of the thermal insulation covering sections 4300 onto the snow heap H.

In the embodiment shown, the covering section coupler 4052 comprises cable-connecting members 4064, 4066. More particularly, the covering section coupler 4052 comprises upper cable-connecting members 4064 (four, in the embodiment shown) for instance secured to the cable-guiding plate 4054 (for instance to an outer face thereof, considered with respect to the covering section-receiving portions 4058). As represented in FIGS. 14, 17A and 17B, the upper cable-connecting members 4064 are configured to guide upper covering section-fastening links 4110 extending above the thermal insulation covering sections 4300. In the embodiment shown, the upper covering section-fastening links extend substantially parallel to each other and substantially perpendicularly to the covering section rows 4301 and the rows formed by the covering section couplers 4052. The covering section coupler 4052 further comprises lower cable-connecting members 4066 (or cable-receiving recesses 4066) for instance formed or secured in the covering section-separating plate 4056 or in the snow heap-engaging base 4062. As represented in FIGS. 14, 17A and 17B, the lower cable-connecting members 4066 are configured to guide lower covering section-fastening links 4112 extending below the thermal insulation covering sections 4300. In the embodiment shown, the lower covering section-fastening links 4112 extend substantially parallel to each other and substantially perpendicularly to the covering section rows 4301 and the rows formed by the covering section couplers 4052.

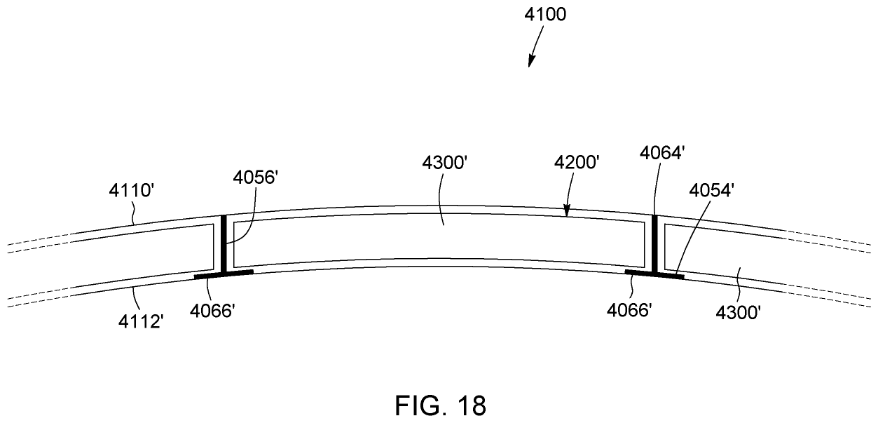

It is appreciated that the shape, the configuration, and the location of the covering section couplers and/or the upper and lower covering section-fastening links can vary from the embodiment shown. For instance, as represented in FIG. 18, it could be conceived a thermal insulation covering 4200′ of a thermal insulation assembly 4100′ wherein the covering section couplers 4052′ would have a substantially inverted T-shaped cross-section, and would thus comprise a lower cable-guiding plate 4054′ with lower cable-connecting members 4066′ and a covering section-separating plate 4056′ extending upwardly from the lower cable-guiding plate 4054′. The covering section-separating plate 4056′ could comprise upper cable-connecting members 4064′. The covering section couplers 4052′ would thus be shaped and dimensioned to guide upper and lower covering section-fastening links 4110′, 4112′ above and below the thermal insulation covering sections 4300′. It could also be conceived covering section couplers having a substantially C-shaped cross-section, a substantially 90 degree-rotated H-shaped cross-section or any other shape forming one or more covering section-receiving portions.

Moreover, it is appreciated that the shape and the configuration of the thermal insulation covering sections 4300 can vary from the embodiment shown. It could for instance be conceived thermal insulation covering sections that would define thermal insulation chamber shaped and dimensioned to be inflated and/or to receive one or more thermal insulation cushions and/or insulating material.

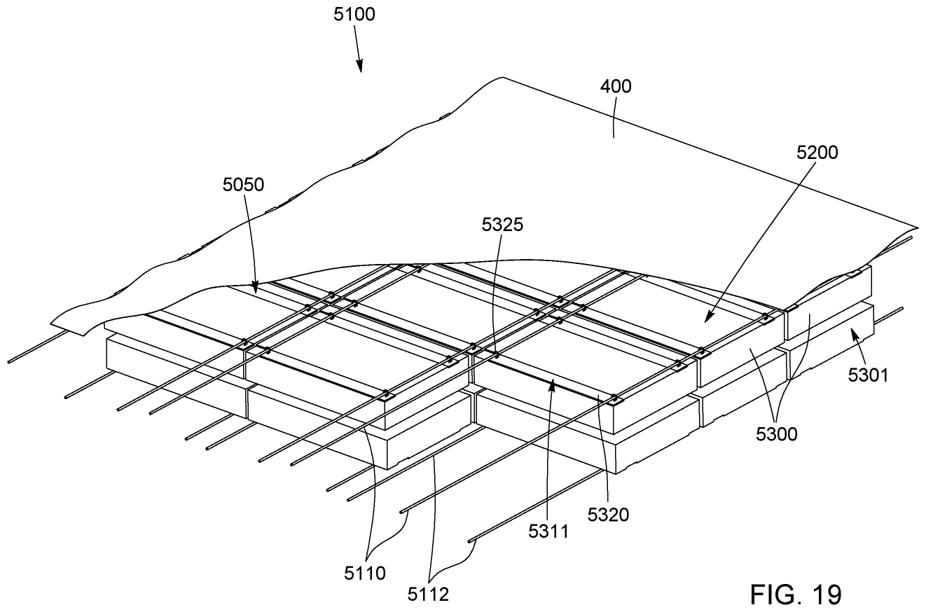

FIG. 19 represents another possible embodiment of a plurality of thermal insulation covering sections 5300 forming together a thermal insulation covering 5200 of a flexible snow heap thermal insulation assembly 5100. In the embodiment shown, the thermal insulation covering sections 5300 form together a plurality of covering section rows 5301.

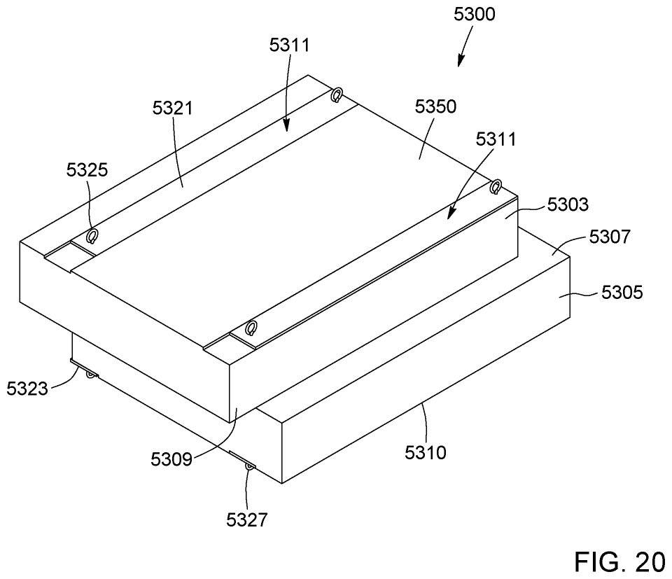

In the embodiment shown, the thermal insulation covering section 5300 has a height h comprised between about 1 inch and about 40 inches, for instance comprised between about 3 inches and about 24 inches. In the embodiment shown, the thermal insulation covering section 5300 has a length comprised between about 1 foot and about 12 feet. In the embodiment shown, adjacent thermal insulation covering sections 5300 are configured in an overlapping configuration. More particularly, as represented in FIG. 20, the thermal insulation covering section 5300 comprises an upper covering portion 5303 and a lower covering portion 5305 extending substantially parallel to each other in an offset manner so as to form abutting surfaces 5307, 5309 (for instance horizontal and vertical abutting surfaces 5307, 5309). The thermal insulation covering section 5300 is thus shaped and dimensioned for the upper covering portion 5303 of a first thermal insulation covering section 5300 to abut against the lower covering portion 5305 of a second thermal insulation covering section 5300. In other words, the upper covering portion of the first thermal insulation covering section is superposable against the lower covering portion of the second thermal insulation covering section to provide a flexible interconnexion between the first and second thermal insulation covering sections. In yet other words, the thermal insulation covering sections 5300 are shaped and dimensioned to increase the stability of the thermal insulation covering 5200 formed by the assembly of the thermal insulation covering sections 5300. In yet other words, the upper covering portion 5303 and the lower covering portion 5305 are vertically and/or horizontally offset with regards to each other so as to form vertical and/or horizontal abutting surfaces for adjacent thermal insulation covering sections to be easily and stably superposed onto each other.

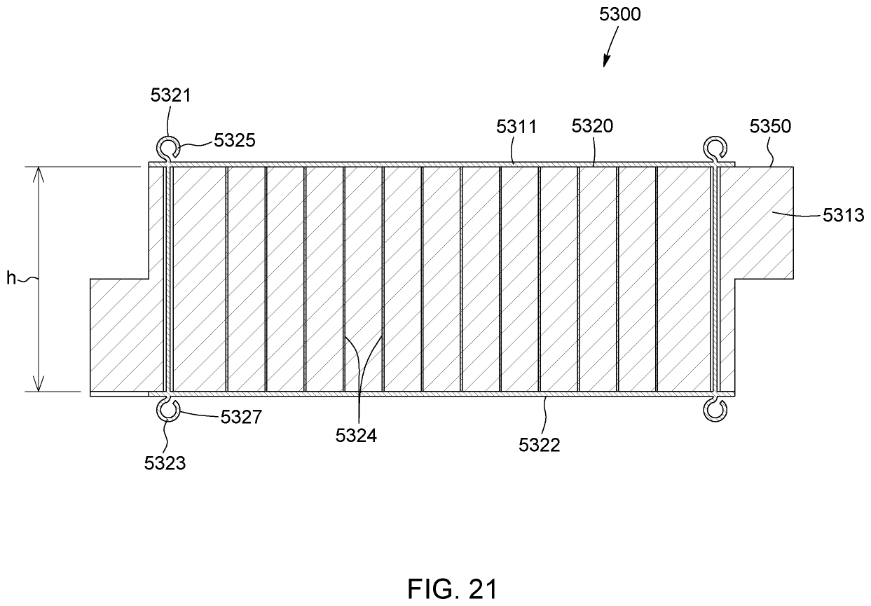

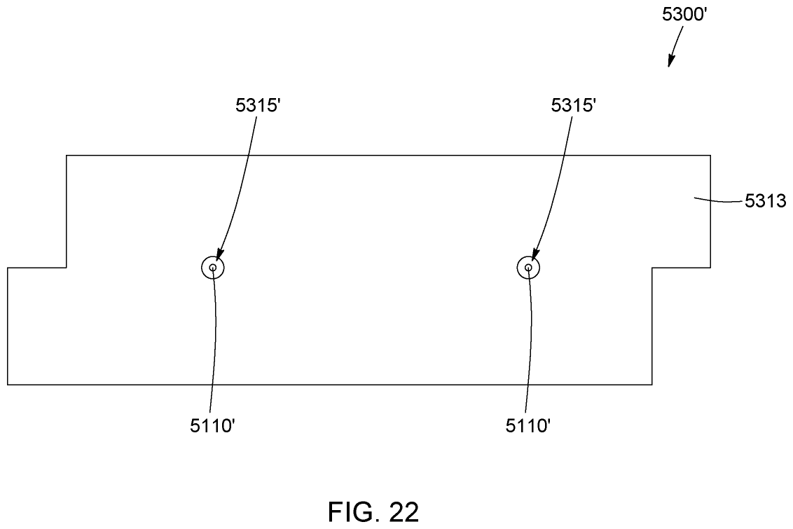

In the embodiment shown, as represented in FIG. 21, the thermal insulation covering section 5300 comprises an inner reinforcing grid 5311 (or stiffening grating 5311 or stiffening grid 5311, or stiffening matrix 5311 or reinforcing inner matrix 5311, for instance made at least partially of plastics, wood, steel, or any other material having rigidity properties) and a thermal insulation body 5313 made at least partially by an insulating material (for instance and without being limitative polystyrene, polyurethane, polyethylene or any other, either new or recycled, insulating material, for instance a material having rigidity properties). The inner reinforcing grid 5311 extends at least partially within the thermal insulation body 5313 (is for instance at least partially embedded therein, for instance during the manufacturing of the thermal insulation covering section 5300). For instance, the inner reinforcing grid 5311 extends in a plane substantially transversal (for instance substantially perpendicular) to the heap-facing layer 5310 and/or the outer layer 5350 of the thermal insulation covering section 5300. In the embodiment shown, the thermal insulation covering section 5300 comprises two stiffening gratings 5311 extending substantially parallel to each other and/or substantially vertically.

In the embodiment shown, the inner reinforcing grid 5311 extends along at least a portion of a height h of the thermal insulation body 5313. In the embodiment shown, the inner reinforcing grid 5311 extends along at least an entirety of the height h of the thermal insulation body 5313. In the embodiment shown, the inner reinforcing grid 5311 comprises upper and lower reinforcing plates 5320, 5322 extending substantially parallel to each other, and a plurality of reinforcing rods 5324 extending substantially parallel to each other between the upper and lower reinforcing plates 5320, 5322 and spaced apart from each other, for instance to receive insulating material therebetween. In the embodiment shown, the inner reinforcing grid 5311 further comprises upper and lower covering section-assembling portions 5321, 5323 (or upper and lower cable-receiving portions 5321, 5323) protruding respectively from the outer layer 5350 and the heap-facing layer 5310. In the embodiment shown, the upper and lower covering section-assembling portions 5321, 5323 protrude respectively from the upper and lower reinforcing plates 5320, 5322. In the embodiment shown, the upper and lower covering section-assembling portions 5321, 5323 comprise upper and lower cable-connecting members 5325, 5327 (or upper and lower cable-receiving eyelets 5325, 5327).

As represented in FIG. 19, the upper cable-connecting members 5325 are configured to guide upper covering section-fastening links 5110 extending above the thermal insulation covering sections 5300. In the embodiment shown, the upper covering section-fastening links extend substantially parallel to each other and substantially perpendicularly to the covering section rows 5301. The lower cable-connecting members 5327 are configured to guide lower covering section-fastening links 5112 extending below the thermal insulation covering sections 5300. In the embodiment shown, the lower covering section-fastening links 5112 extend substantially parallel to each other and substantially perpendicularly to the covering section rows 5301 and substantially perpendicularly to the inner reinforcing grids 5311. The grids could however be arranged in a plane substantially perpendicular to the plane in which they extend in the embodiment shown.

It is appreciated that the shape, the configuration, and the location of the inner reinforcing grid, the upper and lower covering section-assembling portions 5321, 5323 and/or the upper and lower covering section-fastening links can vary from the embodiment shown. For instance, as represented in FIG. 22, it could be conceived a thermal insulation covering section 5300′ in the thermal insulation body 5313 of which cable-receiving apertures 5315′ (or cable-receiving through openings 5315′) could be formed to receive covering section-fastening links 5110′. Cable-guiding sheaths could be arranged in the cable-receiving apertures 5315′. The cable-receiving apertures 5315′ can either be formed once the thermal insulation covering section 5300′ has been manufactured, or the covering section-fastening links can be installed within the thermal insulation covering section during its manufacturing (for instance by arranging the covering section-fastening links in a mold, before injecting the insulating material forming the thermal insulation body 5313 of the thermal insulation covering section). The shape and dimensioned of the inner reinforcing grid are not limited to the embodiments shown and could be made of one or more bars. In some embodiments, the injected insulating material could have sufficient mechanical properties in order to avoid the use of a grid (to supplement the rigidity). For example and without being limitative, carbon fibers could be added to the injected insulating material in order to reduce brittleness of the insulating material.

Moreover, it is appreciated that the shape and the configuration of the thermal insulation covering sections 5300 can vary from the embodiment shown. It could for instance be conceived thermal insulation covering sections that would define thermal insulation chamber shaped and dimensioned to be inflated and/or to receive one or more thermal insulation cushions and/or insulating material.

### Insulated Matter-Mounting Assembly/Heap-Mounting Assembly

The heap-mounting assembly is configured to secure onto the snow heap the plurality of thermal insulation covering sections in the adjacent configuration, the covering sections forming together the thermal insulation covering. The insulated matter-mounting assembly is thus configured so that the insulated matter-facing layers of the plurality of thermal insulation covering sections at least partially cover the insulated matter and substantially conform thereto. As detailed below, at least some of the elements of the insulated matter-mounting assembly provide a flexible interconnexion between adjacent thermal insulation covering sections.

It should be understood that the securing of the plurality of thermal insulation covering sections onto the snow heap is not limited to a direct securing thereof, but can also refer to an indirect securing to the snow heap: for instance, the covering sections could be secured to the ground surface surrounding the snow heap. Moreover, it is understood that the heap-mounting assembly is configured to assemble together adjacent thermal insulation covering sections, either directly, for instance via he covering section connectors 390 (FIGS. 2 and 3) or via the covering section-fastening straps 3110 linking covering section couplers 3052 of adjacent thermal insulation covering sections 3300 (FIG. 9), or indirectly, for instance via the protective layer 400 (or structural membrane) maintaining the different thermal insulation covering sections 300 against the snow heap S (FIG. 1), via the covering section-fastening links 4110, 4412, 5110, 5112 extending along adjacent thermal insulation covering sections 4300, 5300 (FIGS. 14 and 19).

In some embodiments, the heap-mounting assembly comprises one or more structural membranes extending over at least some of the plurality of thermal insulation covering sections. As mentioned above, with reference to FIGS. 2 to 3, the structural membrane of the heap-mounting assembly can be formed by at least one of the heap-facing layers 310 and the outer layers 350 of the plurality of thermal insulation covering sections 300 forming together the thermal insulation covering 200. In some embodiments, the above-mentioned protective layer 400 (FIG. 1) can form all or part of a structural membrane of the heap-mounting assembly 50. In some other embodiments, the heap-mounting assembly 50 comprises a plurality of structural membranes (for instance a plurality of protective layers 400) connected to each other. In some embodiments, the structural membrane is at least partially made of at least one of a UV resistant material, a light-reflecting material and a water-tight film and/or is at least partially made of a material having one or more of the above-mentioned properties.

As mentioned above, in particular with regards to FIG. 1, the heap-mounting assembly can comprise ground fasteners 120 to secure the structural membrane (i.e. the protective layer 400, in the embodiment shown) to the ground surface S surrounding the snow heap H.

In some other embodiments, as represented in FIGS. 9, 14 and 19, the heap-mounting assembly 3050, 4050, 5050 comprises covering section-fastening links 3110, 4110, 4112, 5110, 5112 coupling together at least some of the plurality of thermal insulation covering sections. In some embodiments, the covering section-fastening links 3110 are secured to at least one of the thermal insulation covering sections 3300. The securing of the covering section-fastening link to the thermal insulation covering section can be either direct (covering section-fastening strap 3110 secured to the covering section-coupling rod 3052—FIG. 9) or indirect (covering section-fastening links 4110, 5110 engaged with cable-connecting members 4064, 5325—FIGS. 14 and 19). The covering section-fastening links can either extend above and/or below the plurality of thermal insulation covering sections (FIGS. 14 and 19) and/or at least partially within at least one of the plurality of thermal insulation covering sections (FIG. 22).

In the embodiments represented in FIGS. 14 and 19, the covering section-fastening links 4110, 4112, 5110, 5112 extend continuously above and/or below the adjacent thermal insulation covering sections 4300, 5300; it could also be conceived a plurality of covering section-fastening portions extending above and/or below and/or within one or more thermal insulation covering sections and securable together.

It is appreciated that the shape, the configuration, and the location of the heap-mounting assemblies can vary from the embodiments shown and the different components of the different embodiments of the heap-mounting assembly could be combined together. For instance, as represented in FIGS. 14 and 19, the heap-mounting assemblies 4050, 5050 could further comprise a protective layer 400 at least partially covering the plurality of thermal insulation covering sections 4300, 5300. The protective layer 400 could be secured to the covering section-fastening links and/or to the thermal insulation covering sections and/or to the covering section couplers and/or to the ground surface surrounding the snow heap

### Method for Forming a Flexible Thermal Insulation Assembly

As represented in FIG. 24, the present disclosure also concerns a method 600 for forming a flexible snow heap thermal insulation assembly 100.

The method 600 might firstly comprise a step of providing a flexible snow heap thermal insulation covering 200 according to the present disclosure. In the embodiment shown, the method 600 comprises a step 610 of providing a plurality of thermal insulation covering sections 300 having at least one insulation chamber 370 formed therein and a step 620 of assembling together the plurality of thermal insulation covering sections 300 to form the flexible snow heap thermal insulation covering 200.

The method 600 then comprises a step 630 of filling at least partially the insulation chambers 370 with an insulating material 140. It is understood that the step 630 of filling at least partially the insulation chambers 370 with the insulating material 140 might be performed in a place different from the one in which the step of providing 610 the plurality of thermal insulation covering sections 300 is performed. In other words, the thermal insulation covering sections 300 when configured in an empty configuration can be sent to a place provided with the insulating material 140 for the thermal insulation covering sections 300 to be at least partially filled with the insulating material 140. The insulation covering sections 300 in the filled configuration might then be transported to a third location, to cover and thermally insulate a snow heap H.

Moreover, it is understood that the steps 620, 630 might be performed in a reverse order, i.e. the insulation chambers 370 of the different thermal insulation covering sections 300 might be filled with the insulating material 140 before assembling together the different thermal insulation covering sections 300.

In the embodiment in which at least some of the insulation chambers 370 are filled with one or more thermal insulation cushions 150 (or thermal insulation bricks 150), the step 630 of filling at least partially the insulation chambers 370 might comprise a step of providing the thermal insulation cushions 150 configured in an empty configuration with an insulating material-filling opening formed therein, a step of filling the thermal insulation cushions 150 with insulating material 140 via the insulating material-filling opening—either manually or automatically—of the thermal insulation cushion, a step of closing the insulating material-filling opening of the thermal insulation cushions 150 and a step of inserting the thermal insulation cushions 150 configured in an at least partially filled configuration into the insulation chamber 370 of the thermal insulation covering section 200. The filling of the thermal insulation cushions 150 can be realized either at a same location as the place of inserting the filled thermal insulation cushions 150 into the insulation chambers 370, or the different steps can be realized at different places.

In the embodiment shown for instance in FIGS. 6A and 6B, the step 610 of providing the plurality of thermal insulation covering sections 300 might comprise a step of providing a first material and a second material, for instance forming respectively a first roll and a second roll. The method might further comprise unfolding the first and second rolls for portions of the first and second materials to face each other. The step 610 then comprises, for instance at regular predetermined intervals, cutting and securing the portions of the first and second materials to form therebetween the insulation chambers 370 of the thermal insulation covering sections 300. For instance, portions of one of the first and second materials are cut to form at least partially peripheral wall portions 376 of the insulation chambers 370, as represented in FIG. 6A. In another embodiment, as represented in FIG. 6B, portions of one of the first and second materials are folded to form the peripheral wall portions 376 of the insulation chambers 370.

The method further comprises in the embodiment shown a step of closing—for instance by bonding (for instance by thermo-welding) together at least a portion of a heap-facing layer 310 and at least a portion of an outer layer 350 of the thermal insulation covering sections 300—an insulating material-filling opening 372 for the insulating material 140 to be maintained into the insulation chamber 370.

The method 600 might further comprise a step of securing—for instance sewing or bonding, by thermally welding or the like—retention straps 130 to at least one of the first and second materials forming respectively the outer layer 350 and the heap-facing layer 310 of the thermal insulation covering sections 300.

As mentioned above, the thermal insulation chamber could also be at least partially directly filled with the insulating material (i.e. not via thermal insulation bricks and/or thermal insulation cushions) or could also at least partially be inflated. Moreover, the insulating material could be introduced into the insulation chamber directly while manufacturing the thermal insulation covering section.

### Method for Thermally Insulating a Snow Heap

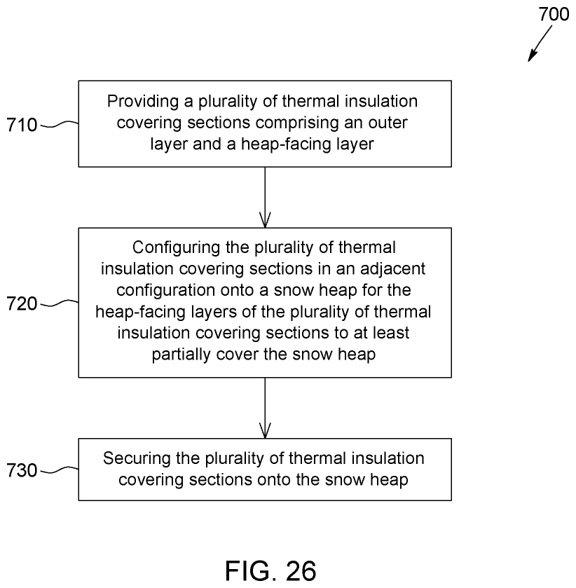

As represented in FIG. 26, the present disclosure also concerns a method 700 for thermally insulating a snow heap H.

The method 700 firstly comprises a step 710 of providing a plurality of thermal insulation covering sections 300 comprising an outer layer 350 and a heap-facing layer 310. The method according to embodiments of the present disclosure may be carried out with a flexible snow heap thermal insulation assembly 100 as those described above.

The method 700 then comprises a step 720 of configuring the plurality of thermal insulation covering sections 300 in an adjacent configuration onto the snow heap with the plurality of thermal insulation covering sections being articulately connected to one another to substantially conform to an outer surface of the snow heap. In an embodiment, at least some of the different thermal insulation covering sections 300 are assembled together prior to the step 720 of configuring them onto the snow heap for them to at least partially cover the snow heap. For instance and without being limitative, the assembled thermal insulation covering sections are supported on a trailer or on a sled to be easily displaced towards the snow heap H. For instance, covering section-fastening links or straps can be secured to the thermal insulation covering sections before configuring the assembly of the thermal insulation covering sections and the covering section-fastening links onto the snow heap.

In another embodiment, a first thermal insulation covering section 300 is arranged onto the snow heap H—for instance at an upper portion thereof—so as to at least partially cover the snow heap H. A second thermal insulation covering section 300 is then provided and assembled directly with the first thermal insulation covering section 300 already partially covering the snow heap H. In other words, the first thermal insulation covering section 300 can constitute a covering-anchoring portion which is subsequently used to arrange the following thermal insulation covering sections. For instance, a plurality of thermal insulation covering sections are arranged onto the snow heap, so as to form a first covering section row. Then, at least one covering section coupler is arranged onto the snow heap, for at least one of the thermal insulation covering sections to be at least partially received in a covering section-receiving portion of the covering section coupler. Then, a second row of thermal insulation covering sections can be arranged onto the snow heap, so that the covering section coupler is arranged between the first and second covering section rows (FIG. 14). In another embodiment, covering section-fastening links can be arranged onto the snow heap. Then, thermal insulation covering sections are successively coupled to the covering section-fastening links for them to be arranged onto and secured to the snow heap.

The method 700 then comprises a step 730 of securing the plurality of thermal insulation covering sections 300 onto the snow heap with the snow heap- facing layers of the thermal insulation covering sections at least partially covering the snow heap and substantially conforming thereto. In the embodiment in which the different thermal insulation covering sections 300 are sequentially installed on the snow heap H, the securing of the different thermal insulation covering sections 300 can be realized sequentially (i.e. after each one of the different thermal insulation covering sections 300 is installed onto the snow heap H) or only once the plurality of thermal insulation covering sections 300 are assembled together.

As mentioned above, in the embodiment wherein at least one of the plurality of thermal insulation covering sections defines a thermal insulation chamber, the method 700 further comprising filling at least partially the thermal insulation chamber with an insulating material. For instance, the filling of the thermal insulation chamber can comprise providing one or more thermal insulation cushions; and arranging the one or more thermal insulation cushions within the thermal insulation chamber.

In the embodiment wherein at least one of the plurality of thermal insulation covering sections defines a thermal insulation chamber and comprises one or more inner air-tight foils extending in the insulation chamber and defining therein inflatable chamber sections, the method 700 might further comprise inflating at least one of the inflatable chamber sections and/or filling at least partially one of the inflatable chamber sections with an insulating material. Alternatively, the inflatable chamber sections could be fluidly connected to a fluid source via an air network or air-circulating pipes in order to keep at least some of the inflatable chamber sections substantially inflated and/or to control an inflation level of one or more of the inflatable chamber sections.

The step 730 of securing the plurality of thermal insulation covering sections 300 onto the snow heap might comprise providing a structural membrane; covering at least one of the plurality of thermal insulation covering sections with the structural membrane; and securing the structural membrane to the ground surface surrounding the snow heap.

The step 730 of securing the plurality of thermal insulation covering sections 300 onto the snow heap might also comprise providing a covering section-fastening link; and securing the covering section-fastening link to at least one of the plurality of thermal insulation covering sections.

The step 730 of securing the plurality of thermal insulation covering sections 300 onto the snow heap might comprise providing one or more covering section couplers defining at least one covering section-receiving portion; arranging the one or more covering section couplers onto the snow heap; and engaging at least one of said plurality of thermal insulation covering sections into said at least one covering section-receiving portion. For instance, the step 730 further comprises securing the covering section-fastening link to the one or more covering section couplers and to the ground surface surrounding the snow heap.

Several alternative embodiments and examples have been described and illustrated herein. The embodiments of the invention described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while the specific embodiments have been illustrated and described, numerous modifications come to mind. The scope of the invention is therefore intended to be limited by the scope of the appended claims.

1. A flexible thermal insulation assembly to thermally insulate matter from an external environment, the flexible thermal insulation assembly comprising:
a plurality of thermal insulation covering sections comprising an outer layer and an insulated matter-facing layer, the plurality of thermal insulation covering sections being configurable in an adjacent configuration wherein the plurality of thermal insulation covering sections are articulately connected to one another to substantially conform to an outer surface of the insulated matter; and
an insulated matter-mounting assembly securing the plurality of thermal insulation covering sections onto the insulated matter with the insulated matter-facing layers of the plurality of thermal insulation covering sections at least partially covering the insulated matter and substantially conforming thereto.

2. (canceled)

3. The flexible thermal insulation assembly according to claim 1, wherein at least one of said plurality of thermal insulation covering sections defines a thermal insulation chamber between the outer layer and the insulated matter-facing layer, and wherein said at least one of said plurality of thermal insulation covering sections comprises a peripheral border extending between the insulated matter-facing layer and the outer layer and at least partially delimiting therewith the thermal insulation chamber.

4. (canceled)

5. (canceled)

6. (canceled)

7. (canceled)

8. (canceled)

9. (canceled)

10. The flexible thermal insulation assembly according to claim 3, wherein said at least one of the thermal insulation covering sections further comprises one or more thermal insulation cushions at least partially contained within the thermal insulation chamber, and wherein said one or more thermal insulation cushions is at least partially made of at least one of a recycled insulating material selected from the group consisting of polystyrene, urethane, expanded polystyrene, expanded polyurethane, and foamed plastic.

11. (canceled)

12. (canceled)

13. The flexible thermal insulation assembly according to claim 3, wherein said one or more thermal insulation cushions comprises one or more cushion-stiffening members and/or is at least partially inflatable.

14. (canceled)

15. (canceled)

16. The flexible thermal insulation assembly according to claim 3, wherein said at least one of the plurality of thermal insulation covering sections comprises at least one covering stiffener extending at least partially in the thermal insulation chamber, and wherein said at least one covering stiffener protrudes outwardly from the insulation chamber and is connectable to the insulated matter-mounting assembly.

17. The flexible thermal insulation assembly according to claim 2, wherein the insulation chamber of said at least one of said plurality of thermal insulation covering sections is at least partially inflatable.

18. (canceled)

19. (canceled)

20. (canceled)

21. (canceled)

22. The flexible thermal insulation assembly according to claim 1, wherein at least some of the plurality of thermal insulation covering sections are configured in an overlapping configuration and wherein first and second adjacent thermal insulation covering sections comprise an upper covering portion and a lower covering portion, the upper covering portion of the first thermal insulation covering section being superposable against the lower covering portion of the second thermal insulation covering section to provide a flexible interconnection between said first and second adjacent thermal insulation covering sections.

23. (canceled)

24. The flexible thermal insulation assembly according to claim 1, wherein at least one of the plurality of thermal insulation covering sections comprises an inner reinforcing grid and a thermal insulation body, the inner reinforcing grid extending at least partially within the thermal insulation body.

25. (canceled)

26. (canceled)

27. (canceled)

28. (canceled)

29. The flexible thermal insulation assembly according to claim 24, wherein the inner reinforcing grid comprises one or more covering section-assembling portions protruding from at least one of the insulated matter-facing layer and the outer layer, and comprising at least one cable-connecting member.

30. The flexible thermal insulation assembly according to claim 3, wherein the peripheral border is at least partially formed by at least a portion of at least one of the insulated matter-facing layer and the outer layer, and wherein at least one of the insulated matter-facing layer and the outer layer of said at least one of the plurality of thermal insulation covering sections is at least partially made of at least one of polyurethane, TPO (Thermo Plastic Olefin), PVC (Polyvinyl chloride), EPDM (ethylene propylene diene monomer), polyurethane, composite high-strength extrusion-coated textile, tear-resistant PTFE, and coated fiberglass fabric sheet.

31. (canceled)

32. The flexible thermal insulation assembly according to claim 1, wherein the insulated matter-mounting assembly comprises one or more structural membranes extending over at least some of the plurality of thermal insulation covering sections, and wherein said one or more structural membranes is at least partially made of at least one of a UV resistant material, a light-reflecting material, and a water-tight film.

33. (canceled)

34. (canceled)

35. (canceled)

36. The flexible thermal insulation assembly according to claim 1, wherein the insulated matter-mounting assembly comprises one or more covering section-fastening links coupling together at least two of the plurality of thermal insulation covering sections and providing an articulated connection in-between, and wherein the one or more covering section-fastening links is at least partially secured to said at least two of the plurality of thermal insulation covering sections.

37. (canceled)

38. (canceled)

39. The flexible thermal insulation assembly according to claim 36, wherein the insulated matter-mounting assembly comprises one or more covering section couplers extending at least partially between said at least two of the plurality of thermal insulation covering sections and providing the articulated connection in-between, and wherein said one or more covering section couplers defines at least one covering section-receiving portion.

40. (canceled)

41. (canceled)

42. (canceled)

43. (canceled)

44. The flexible thermal insulation assembly according to claim 39, wherein said one or more covering section couplers comprises one or more cable-connecting members, and wherein said one or more cable-connecting members are connected to said one or more covering section-fastening links and wherein said one or more covering section-fastening links extend at least one of above and below at least some of the plurality of thermal insulation covering sections.

45. A flexible thermal insulation assembly to thermally insulate matter from an external environment, the flexible thermal insulation assembly comprising:
a plurality of thermal insulation covering sections comprising an outer layer and an insulated matter-facing layer, the plurality of thermal insulation covering sections being configurable in an adjacent configuration wherein the plurality of thermal insulation covering sections are articulately connected to one another to substantially conform to an outer surface of the insulated matter; and
an insulated matter-mounting assembly securing the plurality of thermal insulation covering sections onto the insulated matter, the insulated matter-mounting assembly comprising one or more covering section-fastening links securing together at least some of the plurality of thermal insulation covering sections and providing an articulated connection in-between, with the insulated matter-facing layers of the plurality of thermal insulation covering sections at least partially covering the insulated matter and substantially conforming thereto.

46. (canceled)

47. (canceled)

48. (canceled)

49. (canceled)

50. The flexible thermal insulation assembly according to claim 45, wherein at least one of the plurality of thermal insulation covering sections comprises an inner reinforcing grid, and wherein the inner reinforcing grid comprises one or more covering section-assembling portions protruding from at least one of the insulated matter-facing layer and the outer layer, said one or more covering section-assembling portions comprising cable-connecting members.

51. (canceled)

52. (canceled)

53. (canceled)

54. (canceled)

55. (canceled)

56. (canceled)

57. (canceled)

58. The flexible thermal insulation assembly according to claim 45, wherein the insulated matter-mounting assembly comprises one or more covering section couplers extending at least partially between adjacent ones of said plurality of thermal insulation covering sections and providing the articulated connection in-between, wherein said one or more covering section couplers comprises one or more cable-connecting members, wherein said one or more cable-connecting members are connected to said one or more covering section-fastening links, and wherein said one or more covering section-fastening links extend at least one of above and below at least some of the plurality of thermal insulation covering sections.

59. A method for thermally insulating a snow heap supported on a ground surface from an external environment, the method comprising:
providing a plurality of thermal insulation covering sections comprising an outer layer and a snow heap-facing layer;
configuring the plurality of thermal insulation covering sections in an adjacent configuration onto the snow heap with the plurality of thermal insulation covering sections being articulately connected to one another to substantially conform to an outer surface of the snow heap; and
securing the plurality of thermal insulation covering sections onto the snow heap with the snow heap-facing layers of the plurality of thermal insulation covering sections at least partially covering the snow heap and substantially conforming thereto.

60. (canceled)

61. (canceled)

62. (canceled)

63. (canceled)

64. The method according to claim 59, further comprising:
providing a structural membrane;
covering at least one of the plurality of thermal insulation covering sections with the structural membrane; and
securing the structural membrane to the ground surface surrounding the snow heap.

65. (canceled)

66. (canceled)

67. The method according to claim 59, further comprising:
providing one or more covering section couplers defining at least one covering section-receiving portion;
arranging said one or more covering section couplers onto the snow heap;
engaging at least partially at least one of said plurality of thermal insulation covering sections into said at least one covering section-receiving portion;
providing a covering section-fastening link; and
securing the covering section-fastening link to at least one of said one or more covering section couplers and the ground surface surrounding the snow heap.
